(19) United States
(12) Patent Application Publication
(10) Pub. No.: US 2015/0368033 A1
(43) Pub. Date: Dec. 24, 2015

(54) A CAPSULE FOR BEVERAGE DISPENSING APPARATUS

(71) Applicant: N.V. NUTRICIA, Zoetermeer (NL)

(72) Inventors: Joerg KRUG, Steffenberg (DE); Klaus KROESEN, Xanten (DE); Christian SCHMALOR, Sundern-Hagen (DE); Micha Alexander HELD, Delft (NL); Jody James FOSTER, Nottingham (GB); David Anthony MASON, Leicester (GB); Kevin Neville HODGES, Leicester (GB); Gary BURDETT, Amstelveen (NL); Robert STADMAN, The Hague (NL)

(73) Assignee: N.V. NUTRICIA, Zoetermeer (NL)

(21) Appl. No.: 14/766,710

(22) PCT Filed: Feb. 7, 2014
(86) PCT No.: PCT/EP2014/052426

§ 371 Date: Aug. 7, 2015

(30) Foreign Application Priority Data
Feb. 7, 2013 (EP) PCT/EP2013/052424

(51) Int. Cl. B65D 85/804; A47J 31/40

(52) U.S. Cl. CPC B65D 85/8043; A47J 31/407

(57) ABSTRACT

A capsule (550) for use in apparatus for dispensing liquid beverage, the capsule including at least one capsule side wall (551), a capsule base (552) and a capsule lid (553) defining a capsule cavity containing concentrated beverage and first (555) and second (556) capsule conduits wherein the first capsule conduit extends from proximate the lid and terminates remote from the capsule base allowing fluid to be supplied to the capsule away from the capsule base and the second capsule conduit extends substantially along a length of the capsule and terminates adjacent the capsule base allowing fluid to be dispensed from the capsule via the second capsule conduit.

### BACKGROUND OF THE INVENTION

The present invention relates to a capsule for use in a beverage dispensing apparatus, and in one example, to a capsule for use in dispensing liquid infant formula into a nursing bottle.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Breast-feeding is the preferred method of feeding infants. However, there are circumstances that make breast-feeding impossible or less desirable. In those cases infant formulae are a good alternative. The composition of modern infant formulae is adapted in such a way that it meets many of the special nutritional requirements of the fast growing and developing infant.

Infant formula has traditionally been packaged and sold in containers in the form of tins or tubs which allow for safe transport and storage, even after the container has been opened. A quantity of powder is measured out using a scoop into a nursing bottle where it is mixed with an amount of hot or warm water according to the recommendations of the producer.

Making up a bottle not only involves careful dosing of the powdered formula but also requires a correct amount of water at the correct temperature. If the feed is too hot, the infant may be scalded. If too cold, the infant may be disinclined to drink the full amount. Parents will be aware of the difficulties of cooling an overheated bottle while the baby cries impatiently for its feed. Achieving the correct temperature in a quick and easy manner is therefore of primary importance.

Attempts have been made to provide systems capable of automatically dosing infant formula into nursing bottles and making up the bottles ready for use. One such system is described in EP1633226 A2, whereby a quantity of powder is dosed into a bottle which is subsequently filled with water. Other systems use capsules of powdered infant formula to ensure a consistent dose. The sealed capsules also ensure that the infant formula may be stored hygienically prior to use. Machines that use such capsules to prepare bottles of infant formula are described in WO2010028282 and WO201142489.

Although these machines may reduce some of the inconveniences of preparing infant formula, they are nevertheless rather bulky items and occupy considerable space on the already congested kitchen workspace. The bottles are filled in the conventional manner through their necks. The dispensing machines must therefore supply the formula from above necessitating a height sufficient to receive the nursing bottle beneath the outlet.

It is also known to provide dispensing systems for dispensing other beverages, such as coffee, teas or the like. Again however such dispensing machines are typically bulky and occupy considerable space on the already congested kitchen workspace.

### SUMMARY OF THE PRESENT INVENTION

In one broad form the present invention seeks to provide a capsule for use in apparatus for dispensing liquid beverage, the capsule including:

a) at least one capsule side wall, a capsule base and a capsule lid defining a capsule cavity containing concentrated beverage; and,
b) first and second capsule conduits wherein:
   i) the second capsule conduit extends substantially along a length of the capsule and terminates adjacent the capsule base allowing fluid to be dispensed from the capsule cavity via the second capsule conduit; and,
   ii) the first capsule conduit is shorter than the second capsule conduit allowing fluid to be supplied to the capsule cavity away from the capsule base.

Typically the first and second capsule conduits are spaced apart about an axis of the capsule, so that in use the first and second capsule conduits engage either the first or second conduit depending on a relative orientation of the receptacle and capsule.

Typically hot or unheated fluid is supplied to the capsule via the second capsule conduit, unheated fluid or steam is supplied to the capsule via the first capsule conduit and the liquid beverage is supplied via the second capsule conduit.

Typically the first capsule conduit terminates adjacent a baffle or chamber to thereby direct at least one of air and steam entering the capsule.

Typically the first and second capsule conduits in use selectively couple to first and second conduits in a beverage receptacle so that when the first conduit is coupled to a fluid supply, fluid is supplied to the capsule and the liquid beverage is supplied to the receptacle.

Typically the second capsule conduit is spaced apart from the capsule base by a distance that is at least one of:

a) less than 5 mm;

b) less than 2 mm; and,

c) between 1 mm and 2 mm.

Typically the capsule includes at least one element for agitating contents of the capsule.

Typically the element agitates beverage within the capsule cavity upon reciprocating rotation of the capsule.

Typically the element is a paddle mounted within the capsule cavity.

Typically the paddle covers at least one of:

a) between 30% to 95% of a vertical cross section of a capsule cavity;

b) between 40% to 80% of a vertical cross section of a capsule cavity;

c) between 50% to 70% of a vertical cross section of a capsule cavity; and,

d) between 60% to 70% of a vertical cross section of a capsule cavity.

Typically the paddle includes a plurality of apertures.

Typically at least some of the apertures have an area of at least one of:

a) less than 200 mm²;

b) less than 100 mm²;

c) less than 50 mm²; and,

d) between 10 mm² and 40 mm².

Typically the apertures are spaced apart.

Typically the capsule is manufactured using thermoforming or injection moulding with an injection moulded conduit body.

Typically the capsule base, capsule side walls and capsule lid are formed of a common material.

Typically the capsule includes at least one of:

a) a piercable lid; and,

b) a pre-pierced lid.

Typically each capsule conduit has a spike that pierces the capsule lid.

Typically the capsule is at least partially deformable so that in use, during engagement with a receptacle base, each capsule conduit pierces the capsule lid.

Typically at least one of capsule side walls and a capsule rim are deformable to bring the piercable lid into contact with the spikes.

Typically the deformation of the capsule controls tension in the capsule lid to thereby assist in piercing the capsule lid.

Typically the capsule includes a lid engaging plate that engages an underside of a capsule lid when a topside of the lid is engaged by a receptacle base to thereby effect sealing between the capsule and the receptacle base.

Typically the first and second capsule conduits extend through the lid engaging plate.

Typically the capsule includes a conduit body mounted in the cavity, the conduit body including the first and second capsule conduits.

Typically the conduit body includes arms ending in feet that engage an inner surface of the at least one capsule side wall to thereby support the conduit body within the housing.

Typically the capsule includes recesses defining side wall pockets for receiving the feet and for supporting the conduit body within the capsule.

Typically the at least one side wall includes ribs for supporting the conduit body within the capsule cavity.

Typically the conduit body includes at least one paddle.

Typically the conduit body is molded so that arms, paddles and conduits are integrally formed.

Typically the capsule includes a rim extending radially outwardly from a capsule opening, the lid being coupled to the rim.

Typically the lid is selectively coupled to the rim to thereby allow for at least partial removal of the lid thereby allowing beverage concentrate to be removed from the capsule.

Typically the lid is bonded to a first part of the rim with a first bond strength and to a second part of the rim with a second bond strength, the second bond strength being less than the first bond strength.

Typically the first part of the rim is an arcuate segment extending around more than half the circumference of the rim and the second part of the rim is an arcuate segment extending around less than half the circumference of the rim.

Typically the capsule lid includes at least one tab for facilitating at least partial removal of the lid.

Typically the capsule includes a shoulder extending circumferentially around the capsule side wall, the shoulder being for at least one of:

a) partially supporting the capsule in a capsule holder in use; and,

b) spacing the capsules during stacking of the capsules for transport or storage.

Typically the capsule is a single-use disposable capsule.

Typically the capsule is a reusable capsule.

Typically the capsule is substantially non-deformable and wherein the lid is removably mounted to a capsule body including the at least one side wall and base.

Typically the lid includes apertures defining at least part of the first and second capsule conduits.

Typically the second capsule conduit and at least one paddle are supported by the lid.

Typically the capsule includes guides for aligning the capsule in a capsule holder.

Typically the capsule includes at least one control marking, wherein in use production of the liquid beverage is at least partially controlled in accordance with the marking

Typically the control marking includes a bar code.

Typically the capsule includes an alignment marking, and wherein the control marking is positioned relative to the alignment marking so that sensing of the alignment marking can be used to align the control marking with a sensor.

Typically the beverage concentrate is at least one of:

a) a powdered infant formula;

b) a liquid infant formula;

c) a nutritional composition;

d) a medicated formulation; and,

e) an isotonic drink formulation.

Typically the first capsule conduit extends from proximate the lid and terminates remote from the capsule base allowing fluid to be supplied to the capsule away from the capsule base.

Typically the first capsule conduit has a length that is at least one of:

a) less than 40 mm;

b) less than 30 mm;

c) less than 20 mm; and

d) approximately 10 mm long.

Typically the second capsule conduit has a length that is at least one of:

a) greater than 20 mm;

b) approximately 30 mm;

c) greater than 30 mm; and

d) approximately 45 mm.

In another broad form the present invention seeks to provide a capsule for use in apparatus for dispensing liquid beverage, the capsule including:
a) at least one capsule side wall, a capsule base and a capsule lid defining a capsule cavity containing concentrated beverage; and,
b) a conduit body coupled to the capsule to thereby support within the capsule cavity:
   i) a first capsule conduit that in use supplies fluid to the capsule;
   ii) a second capsule conduit that in use at least dispenses fluid from the capsule; and,
   iii) a paddle for agitating contents of the capsule.

In another broad form the present invention seeks to provide a capsule for use in apparatus for dispensing liquid beverage, the capsule including:
a) at least one capsule side wall, a capsule base and a capsule lid defining a capsule cavity containing concentrated beverage; and,
b) a conduit body mounted in the cavity, the conduit body including:
   i) a first capsule conduit that in use supplies fluid to the capsule;
   ii) a second capsule conduit that in use at least dispenses fluid from the capsule; and,
   iii) arms ending in feet that engage an inner surface of the at least one capsule side wall to thereby support the conduit body within the capsule.

It will be appreciated that the broad forms of the invention and their respective additional features may be used individually or in combination.

### BRIEF DESCRIPTION OF THE DRAWINGS

An example of the present invention will now be described with reference to the accompanying drawings, in which:

FIG. 1A is a schematic cross sectional view of an example of an apparatus for dispensing beverage;

FIG. 1B is a schematic cross sectional view of the apparatus of FIG. 1A in a dispensing configuration;

FIG. 2A is a schematic cross sectional view of a second example of an apparatus for dispensing beverage in a pre-load configuration;

FIG. 2B is a schematic cross sectional view of the apparatus of FIG. 2A in a load configuration;

FIG. 2C is a schematic cross sectional view of the apparatus of FIG. 2A in a filling configuration;

FIG. 2D is a schematic cross sectional view of the apparatus of FIG. 2A in a mixing configuration;

FIG. 2E is a schematic cross sectional view of the apparatus of FIG. 2A in a dispensing configuration;

FIG. 3A is a schematic first side view of a first specific example of an apparatus for dispensing beverage;

FIG. 3B is a schematic second side view of the apparatus in FIG. 3A with a mounted bottle;

FIG. 3C is a schematic plan view of an example of the mounting body of FIG. 3A;

FIG. 3D is a schematic perspective view of the mounting body of FIG. 3C;

FIG. 3E is a schematic end view of the mounting body of FIG. 3C;

FIG. 3F is a schematic side view of an example of the capsule holder and spindle of FIG. 3A;

FIG. 3G is a schematic perspective view of the capsule holder and spindle of FIG. 3F;

FIG. 3H is a schematic underside view of the capsule holder of FIG. 3F;

FIG. 3I is a schematic plan view of the spindle of FIG. 3F;

FIG. 3J is a schematic perspective underside view of the capsule holder of FIG. 3F;

FIG. 3K is a schematic perspective plan view of the spindle of FIG. 3F;

FIG. 4A is a schematic side view of an example of a receptacle in the form of a nursing bottle;

FIG. 4B is a second schematic side view of the receptacle of FIG. 4A;

FIG. 4C is a schematic perspective view of the receptacle of FIG. 4A with the base removed;

FIG. 4D is a schematic underside view of an example of the receptacle base;

FIG. 4E is a schematic cross sectional view of the receptacle base;

FIG. 4F is a schematic plan view of an example of the receptacle base;

FIG. 4G is a schematic cross sectional view of the receptacle base of FIG. 4F along the line A-A′ of FIG. 4B;

FIG. 4H is a schematic underside view of the receptacle base of FIG. 4F;

FIGS. 41 and 4J are schematic perspective and plan views of an example of a receptacle base and mounting prior to engagement;

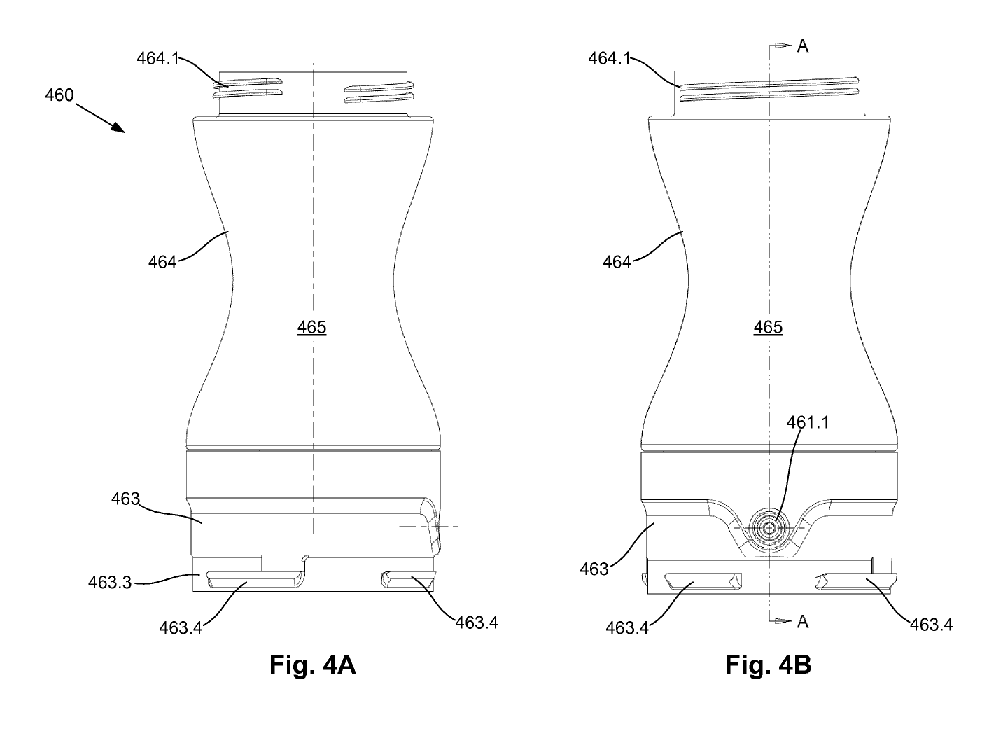

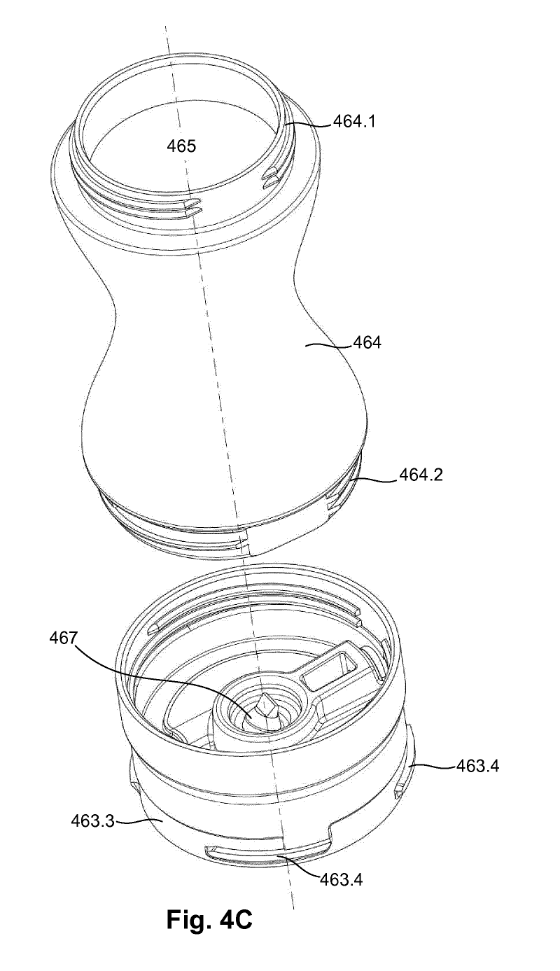

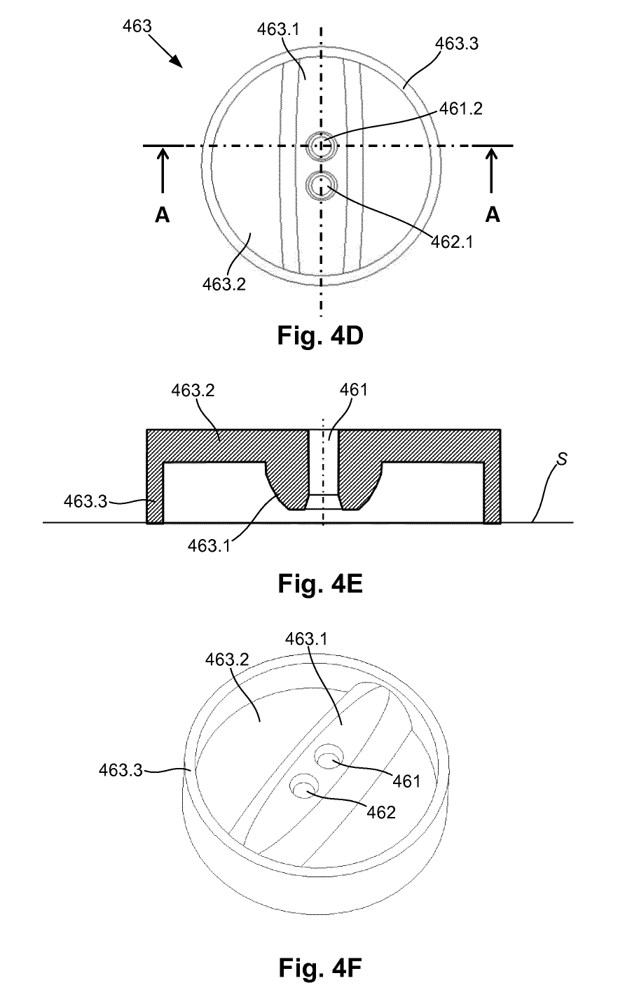

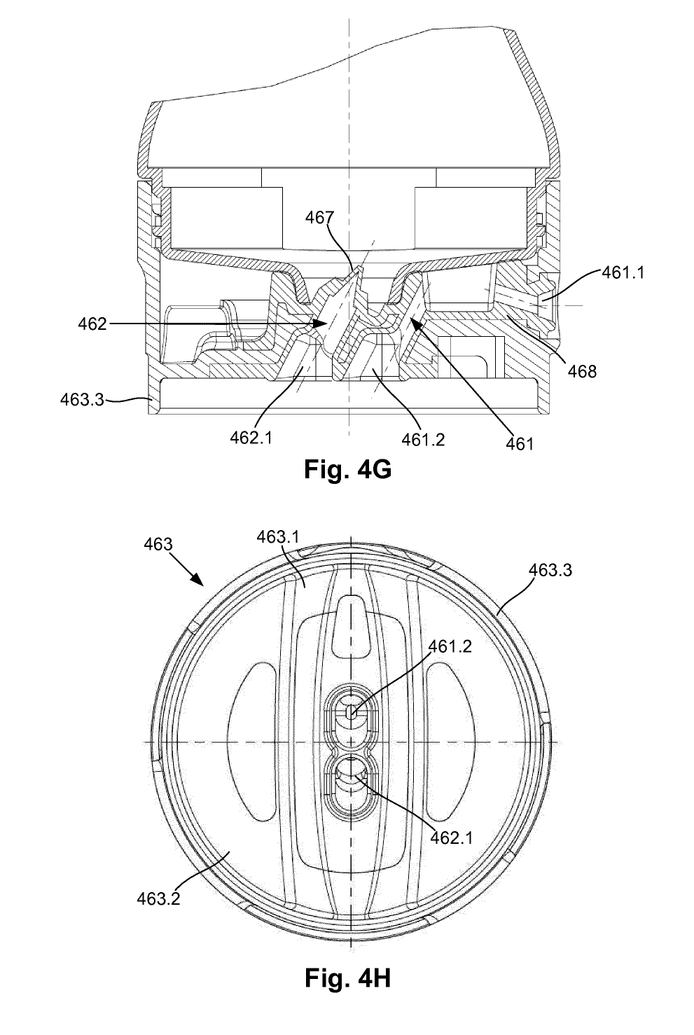

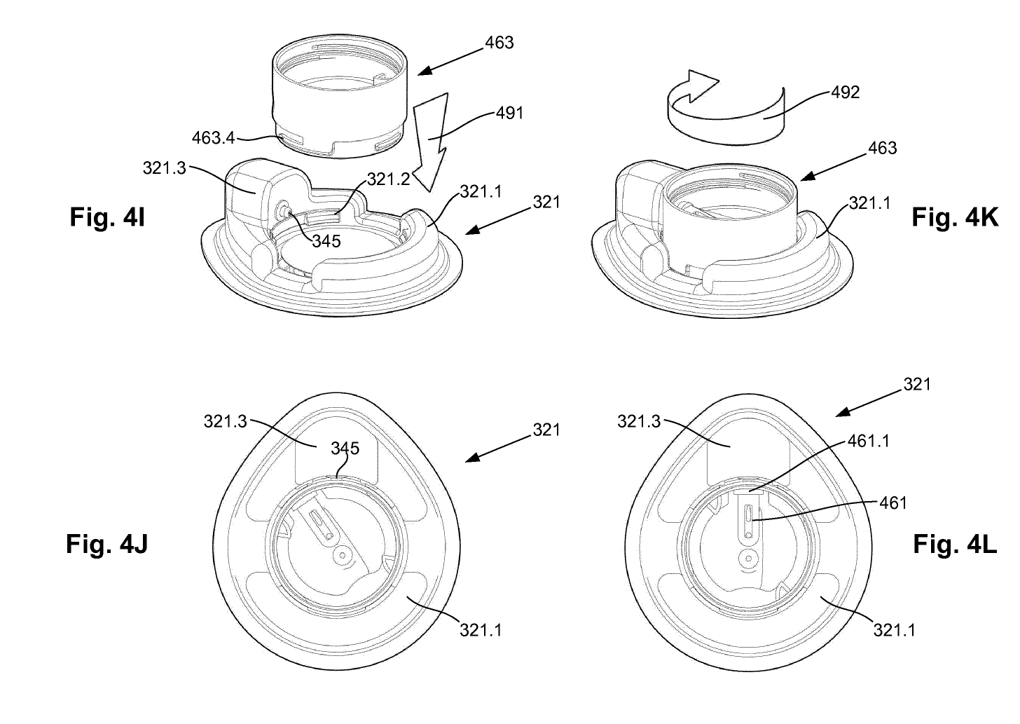

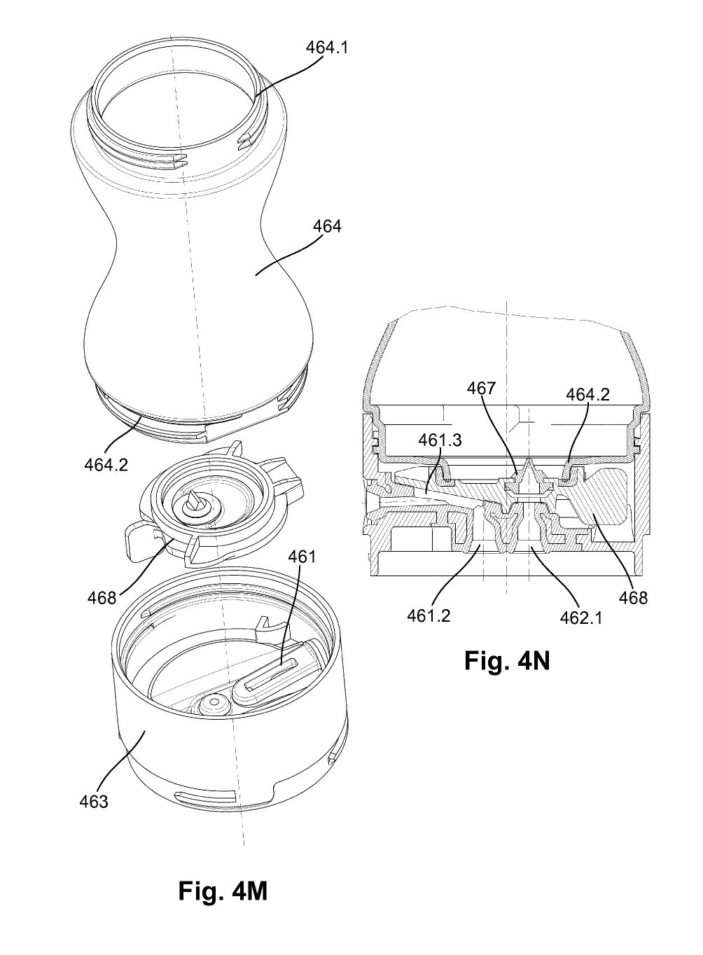

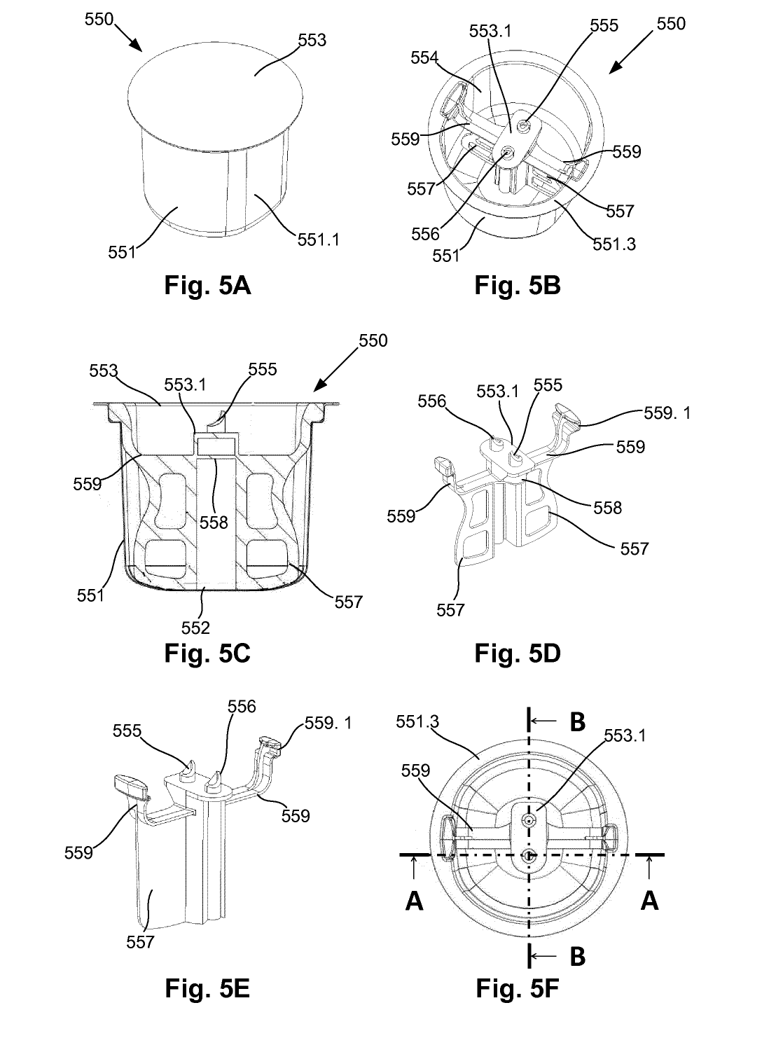

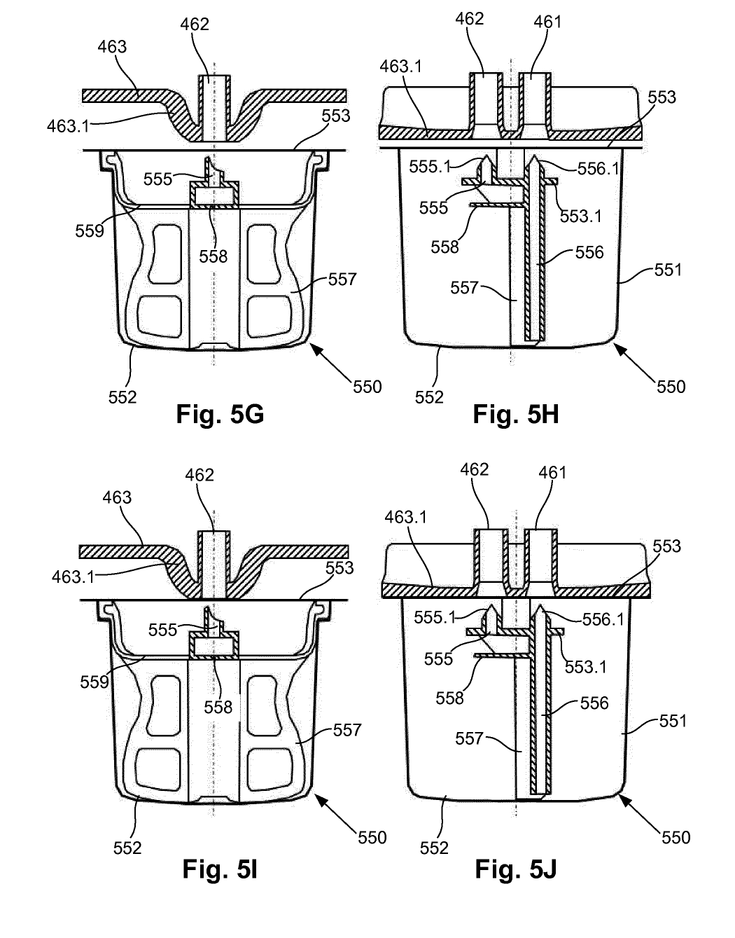

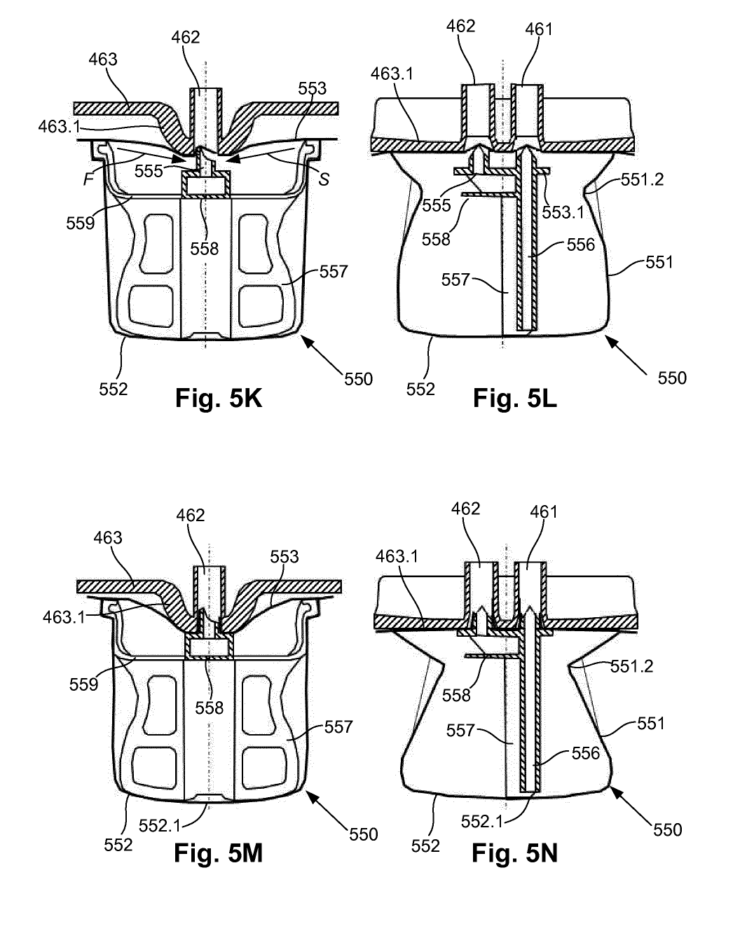

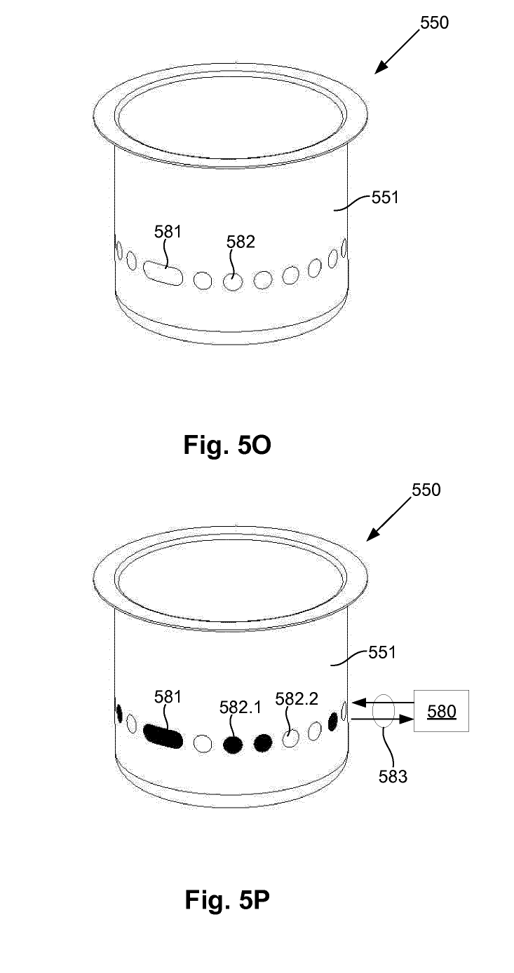

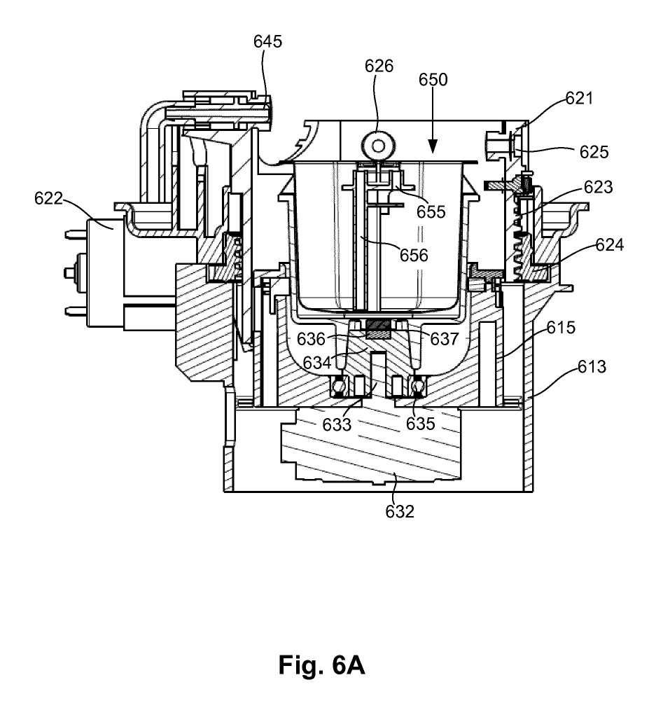

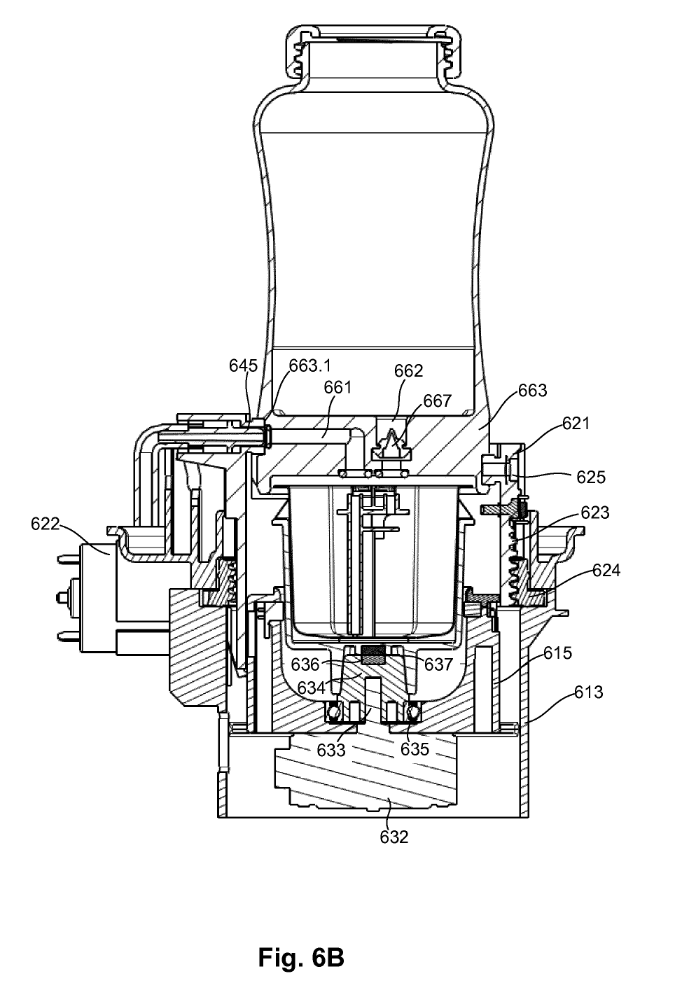

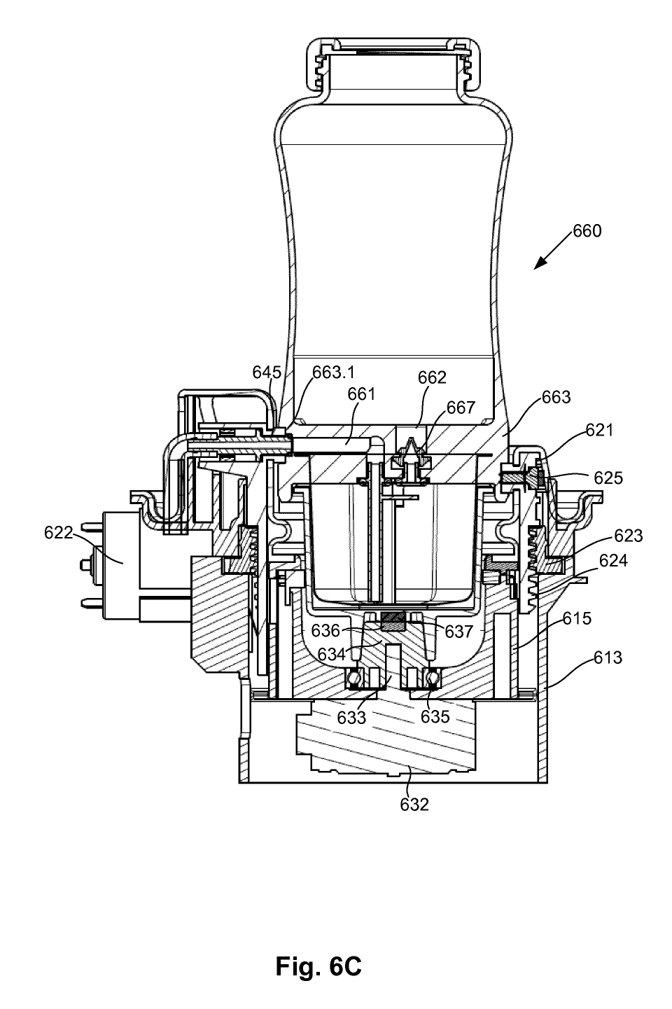

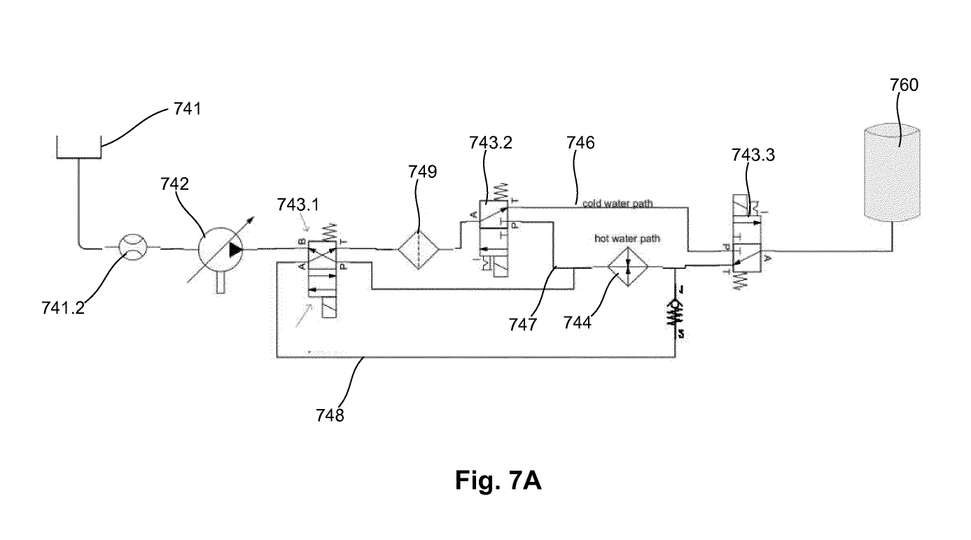

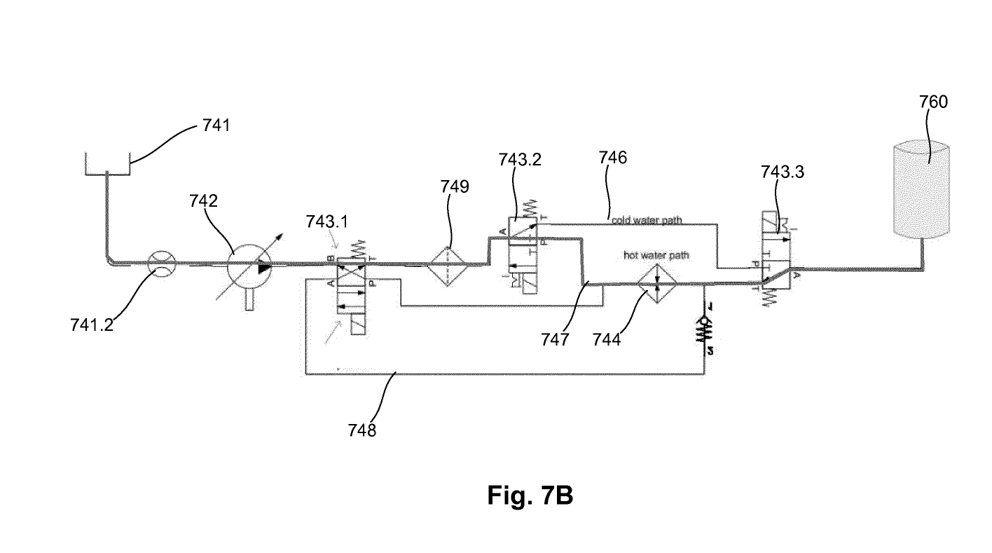

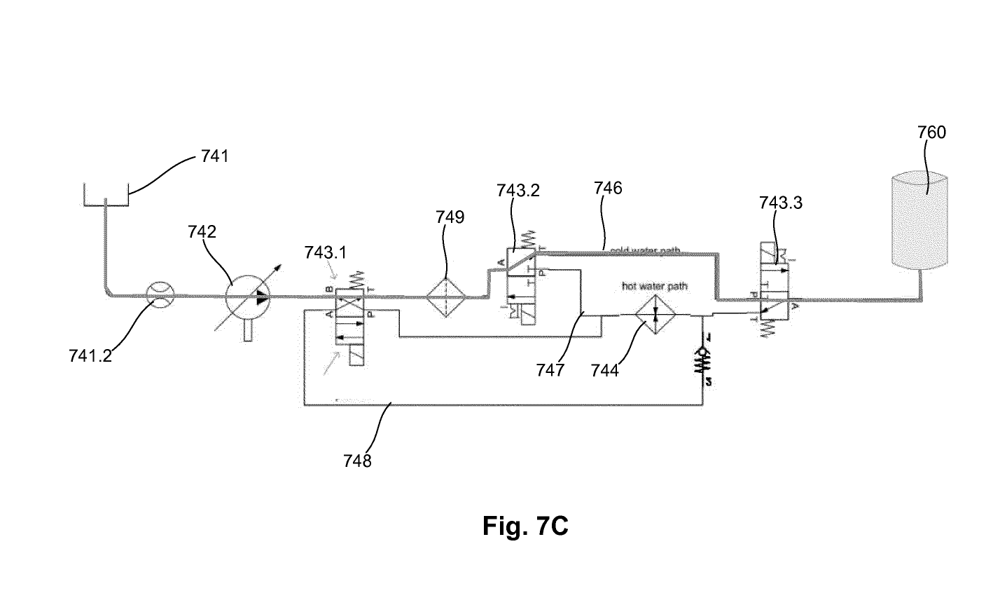

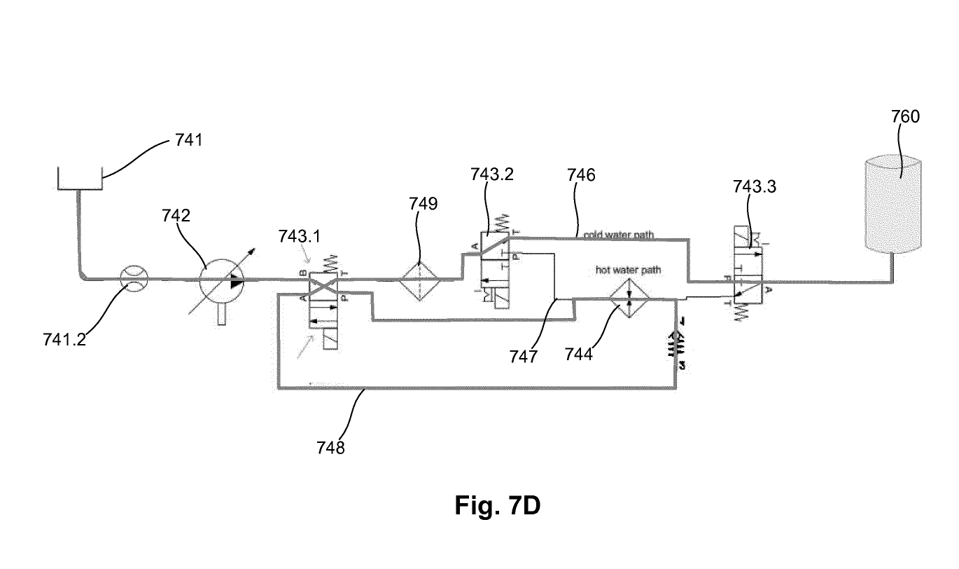

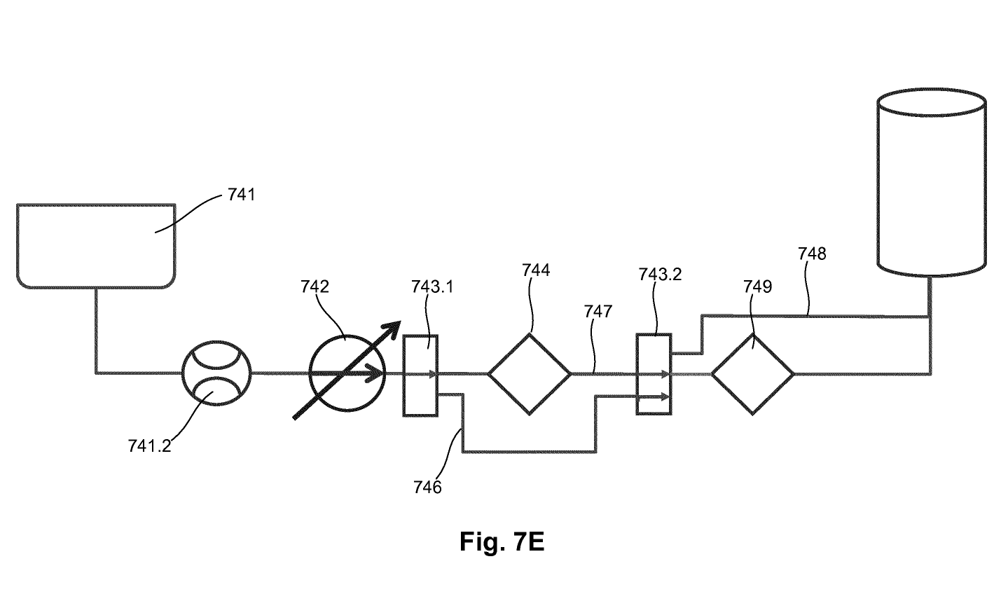

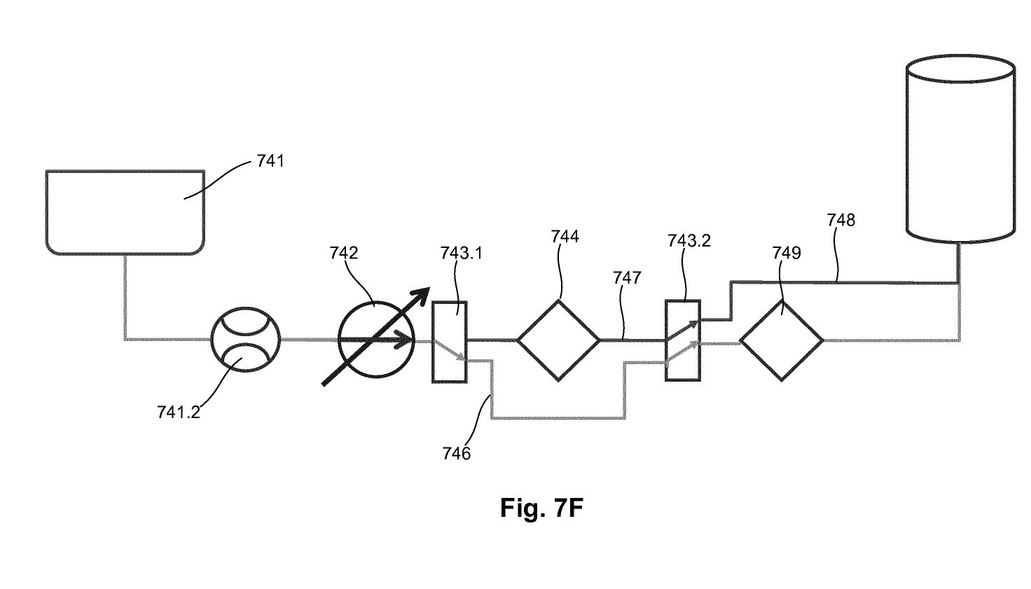

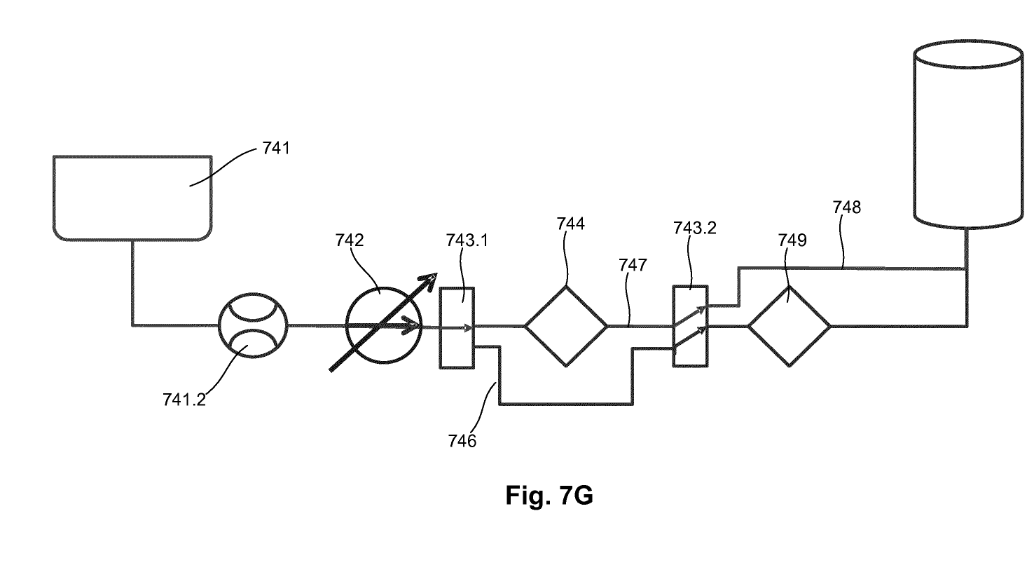

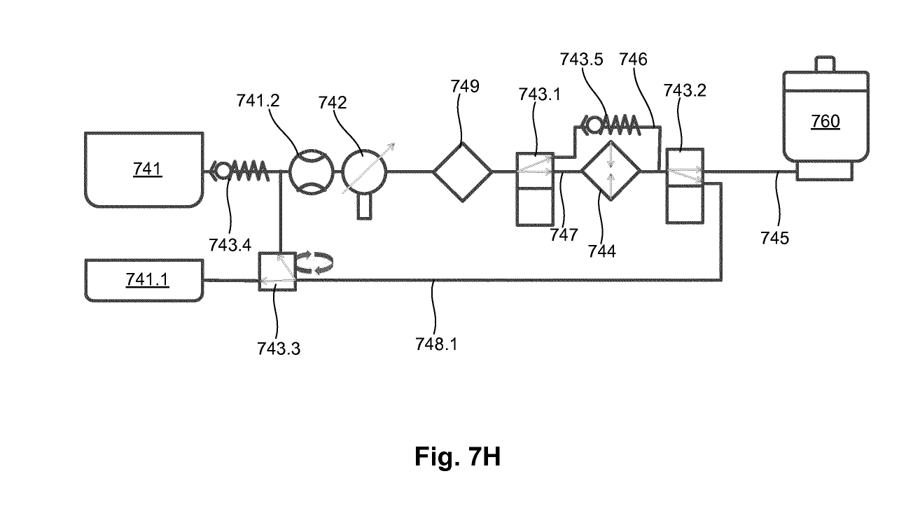

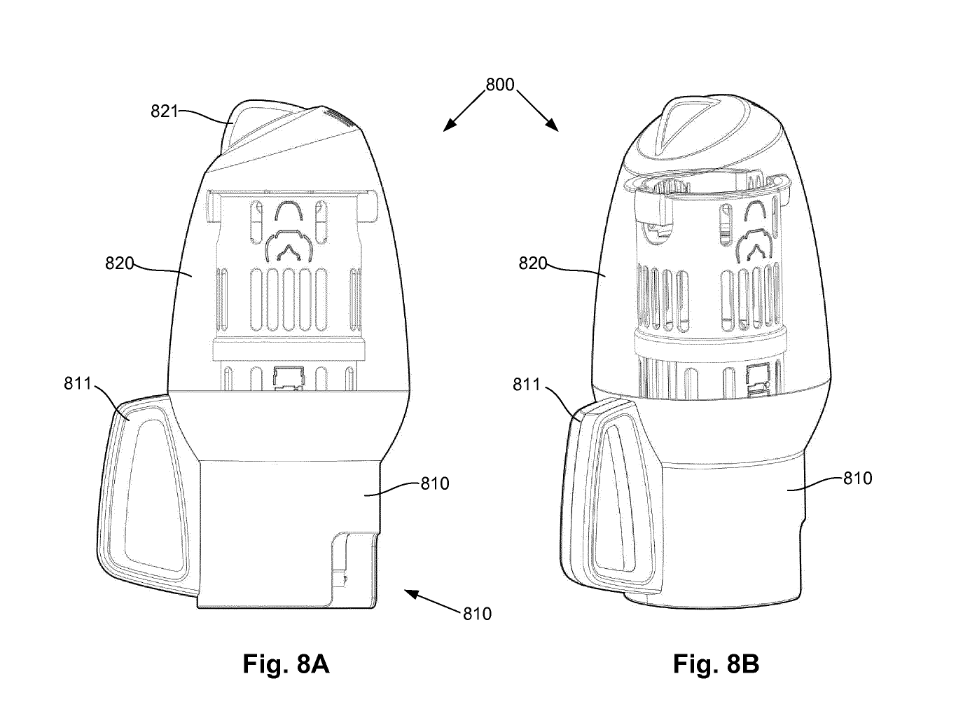

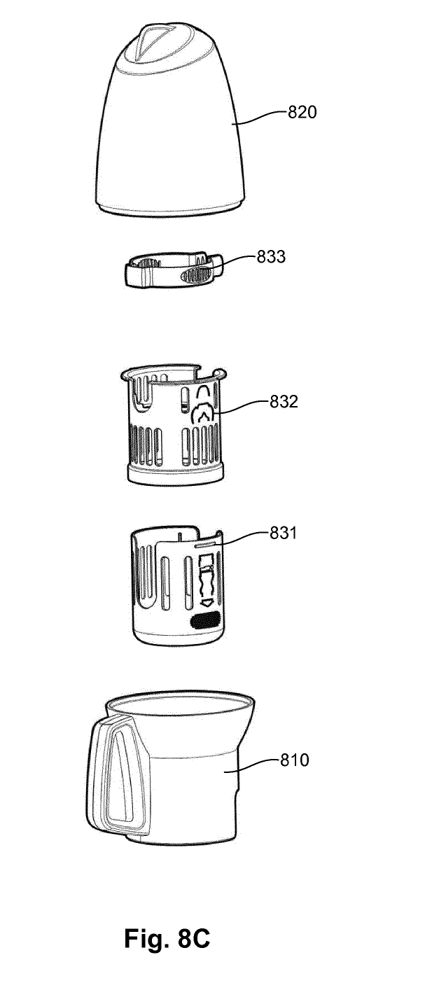

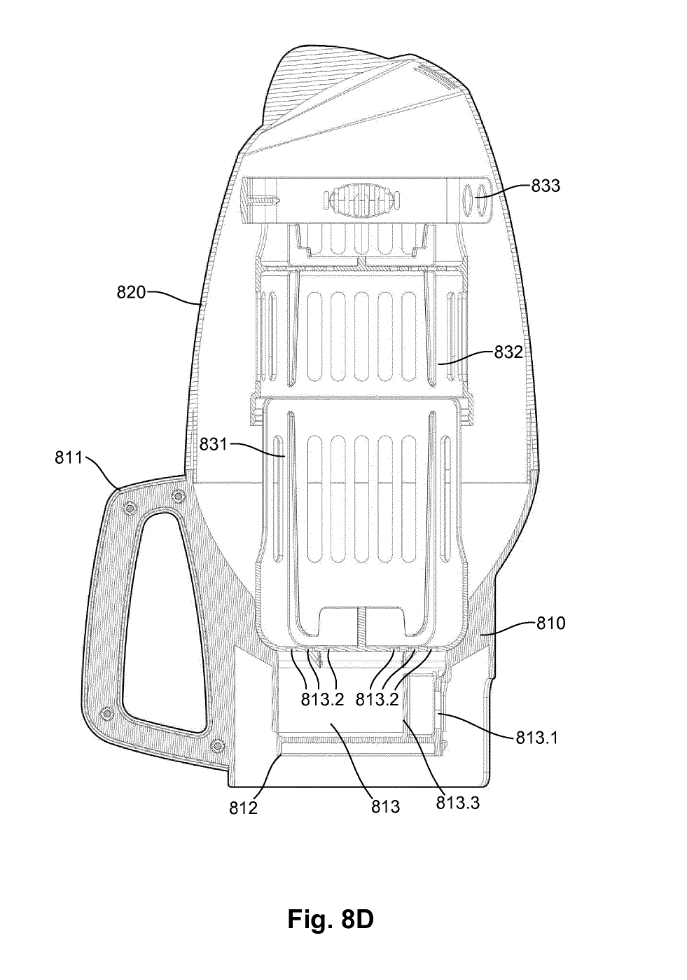

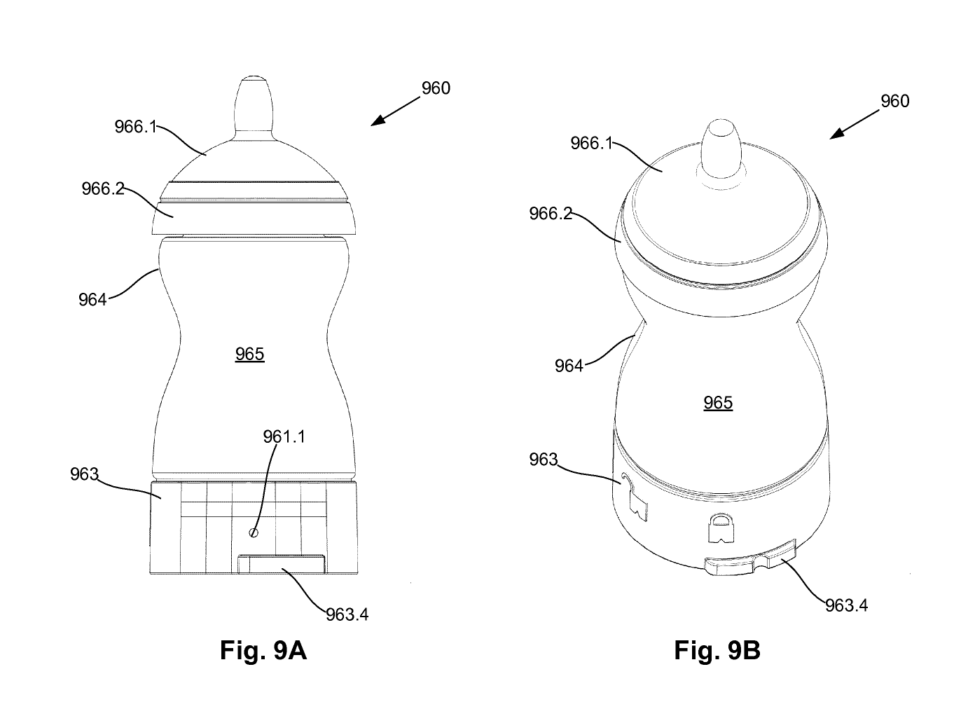

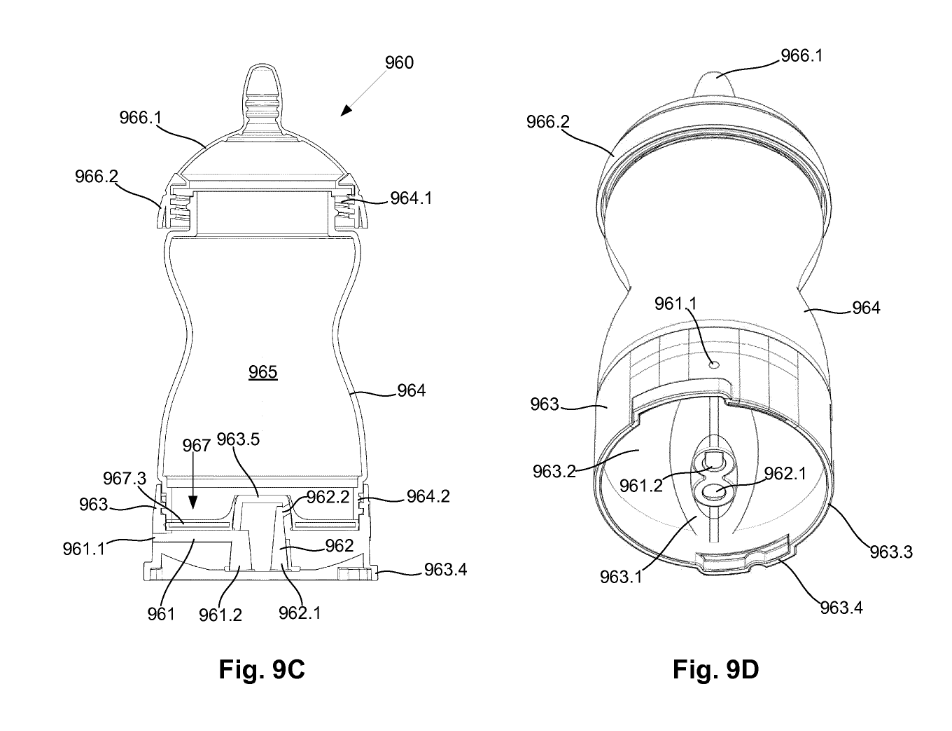

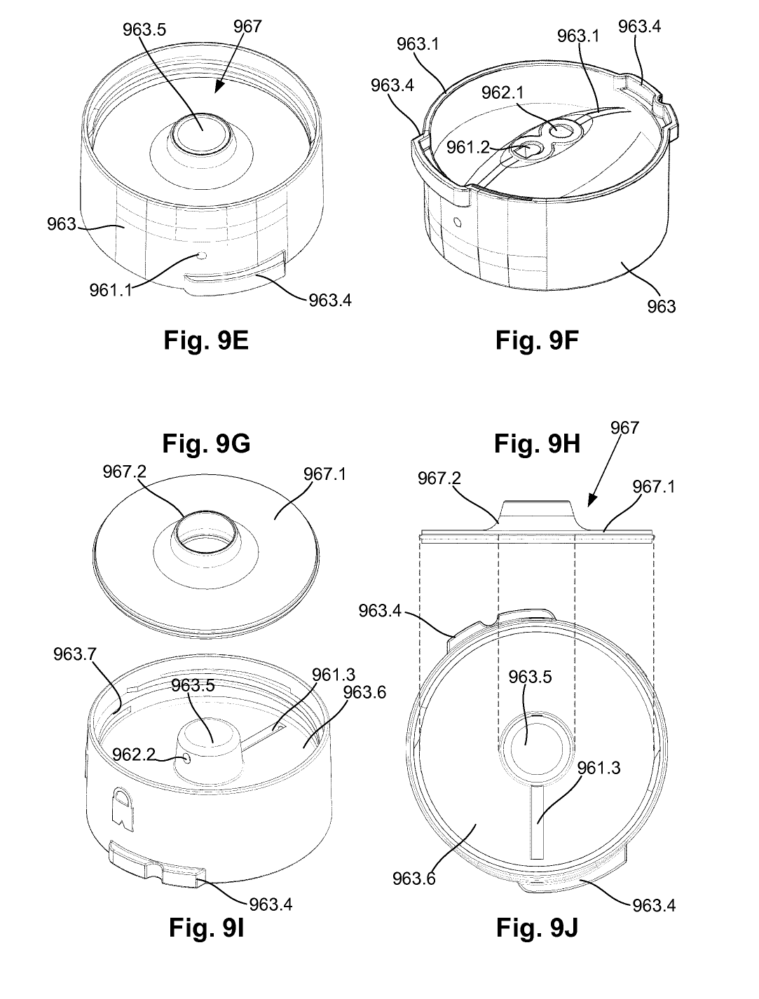

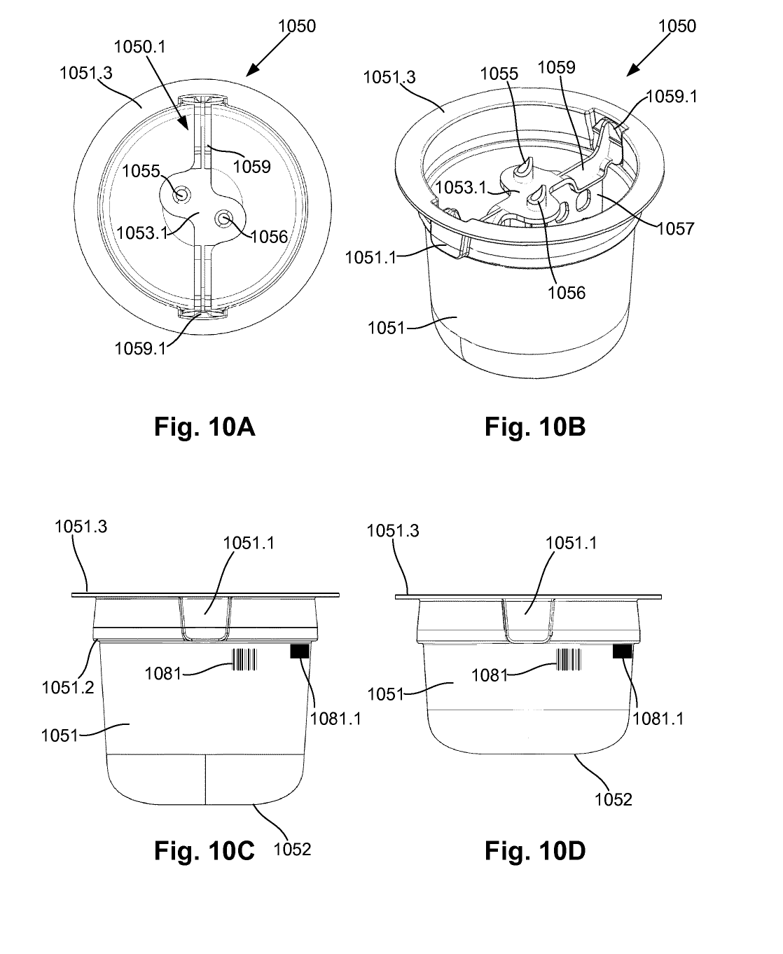

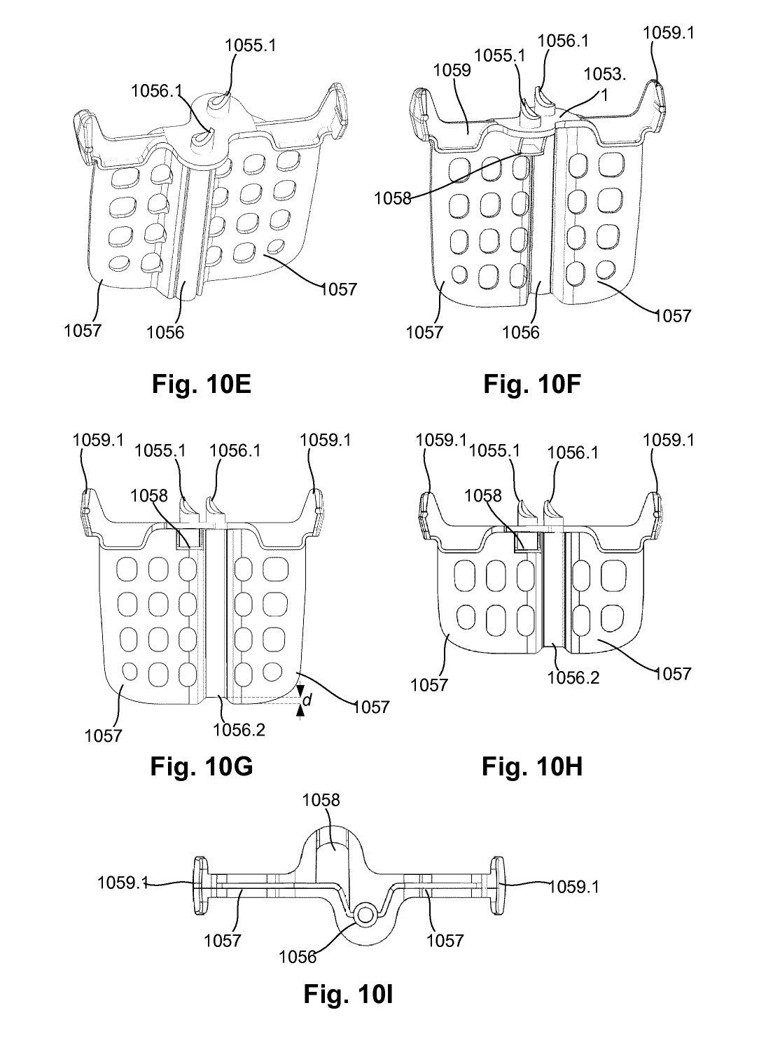

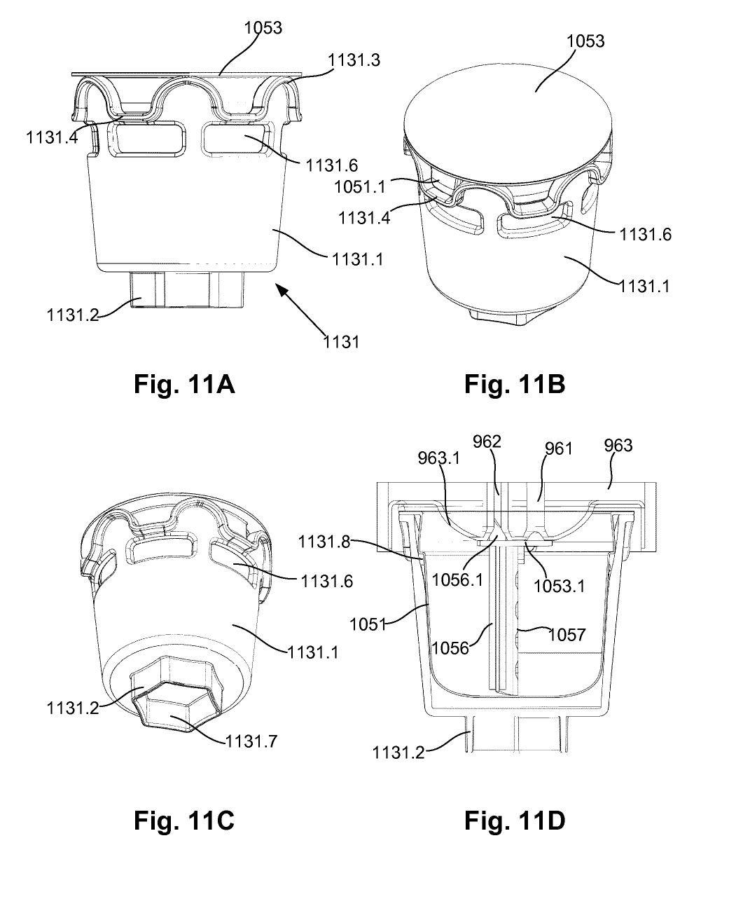

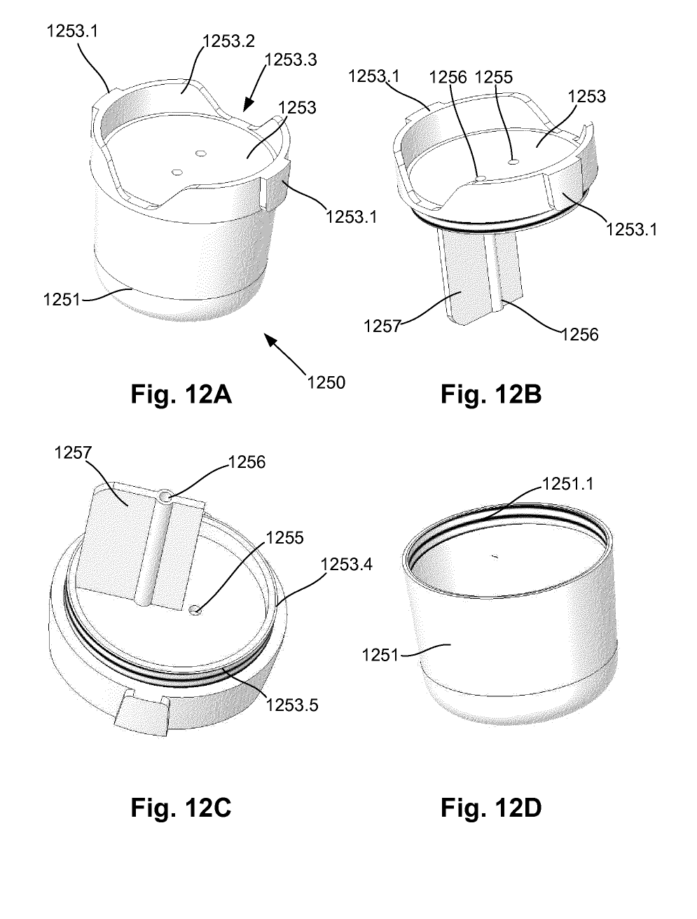

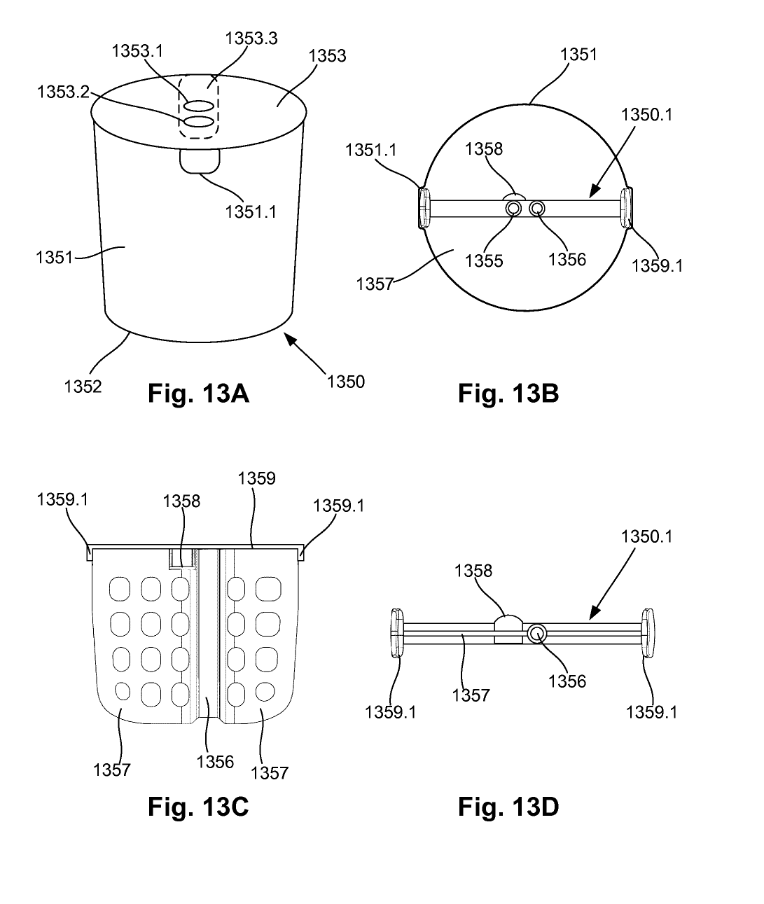

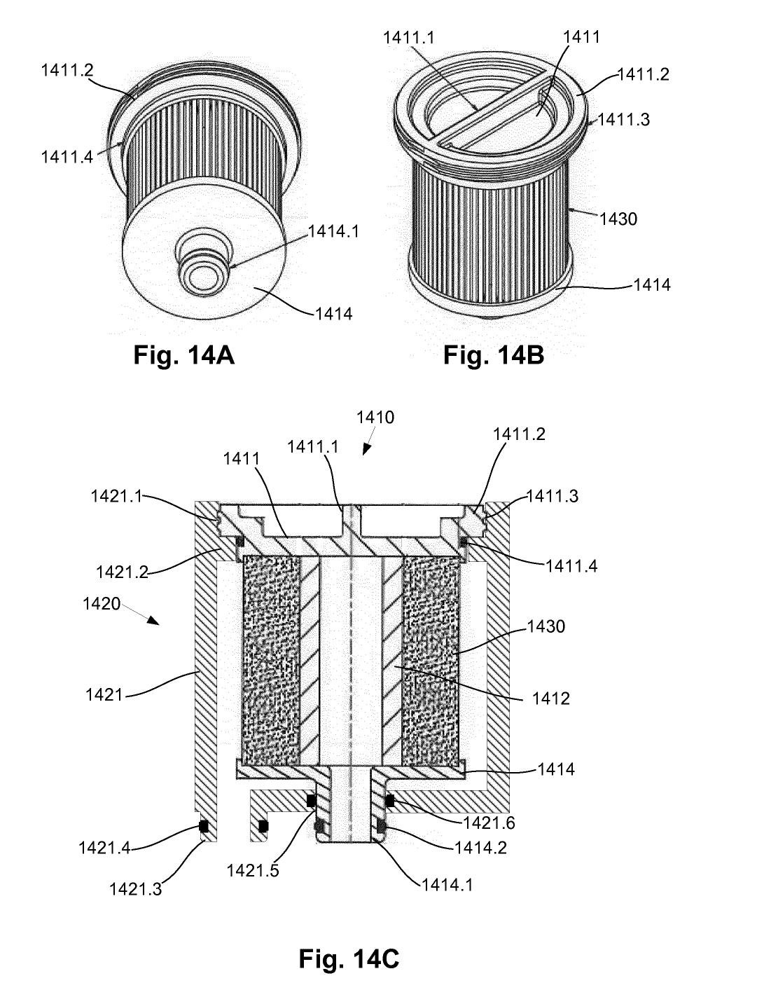

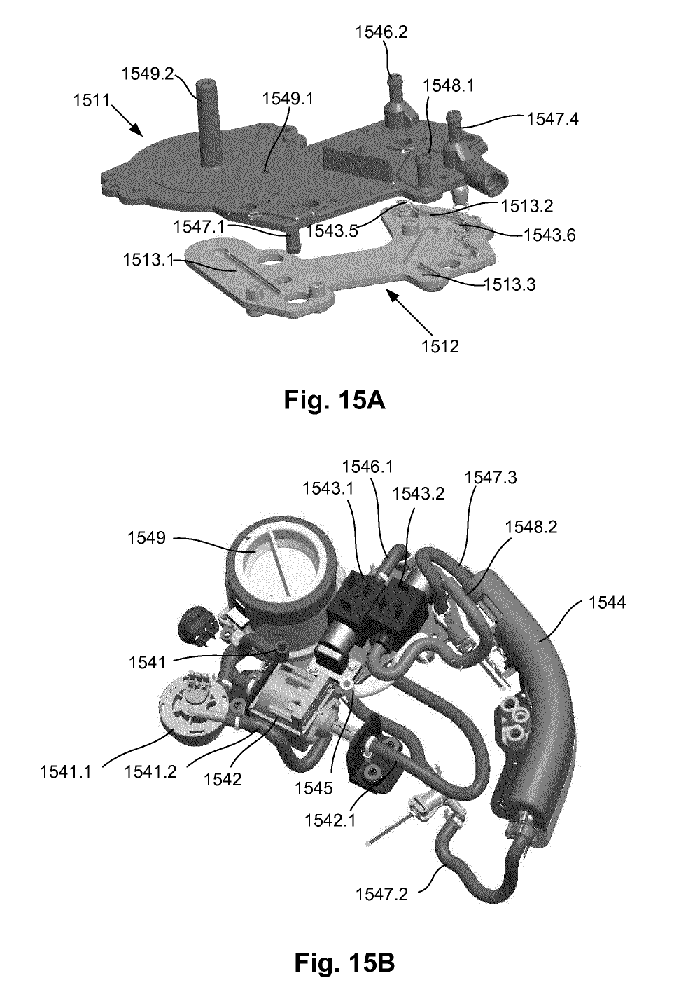

FIGS. 4K and 4L are schematic perspective and plan views of an example of a receptacle base and mounting in engagement;

FIG. 4M is a schematic perspective view of a second example of a receptacle in the form of a nursing bottle;

FIG. 4N is a schematic cross sectional view of the base of the bottle of FIG. 4M;

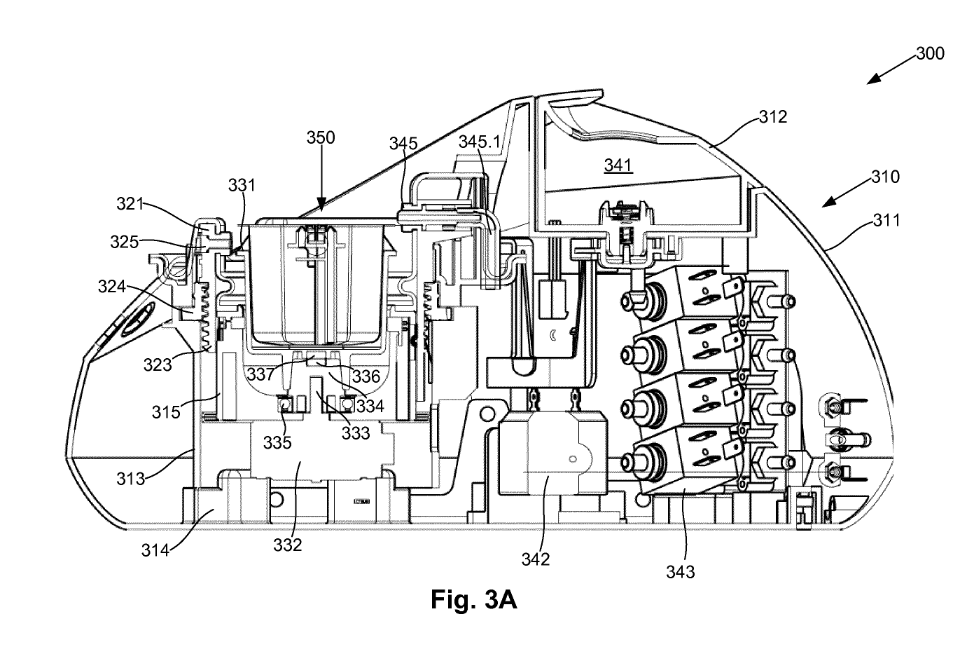

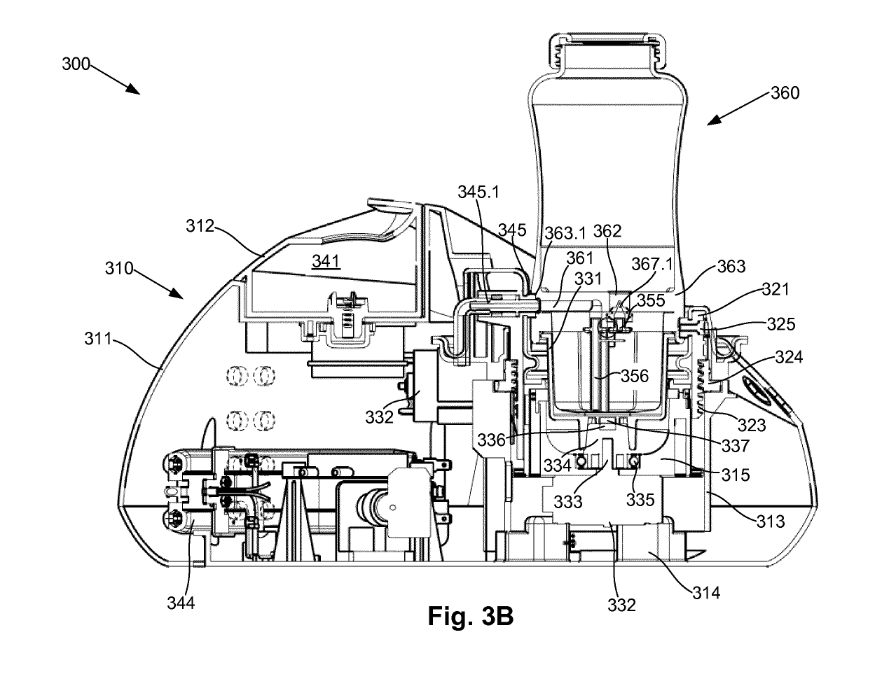

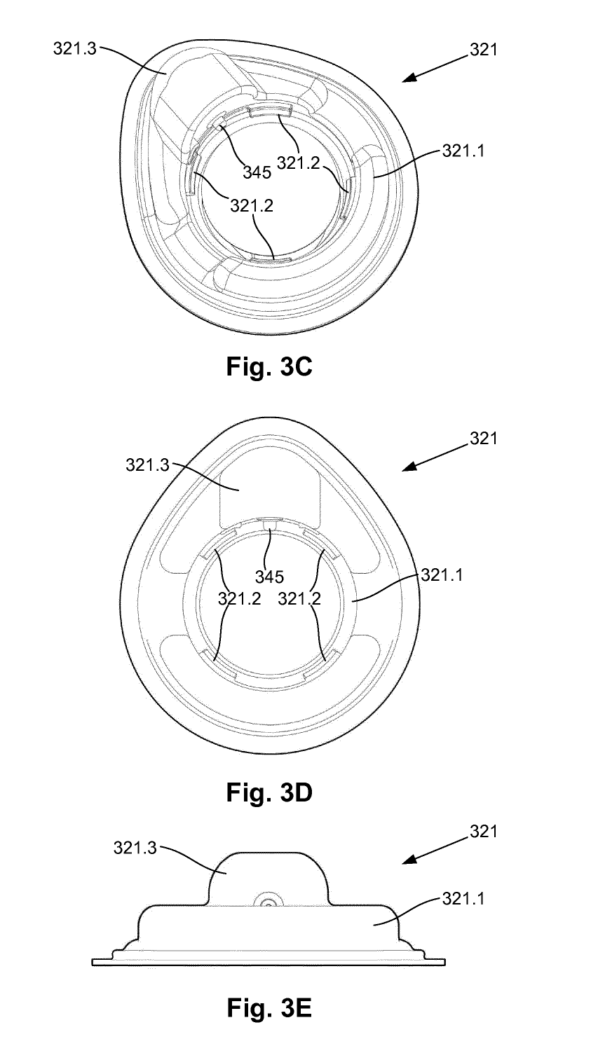

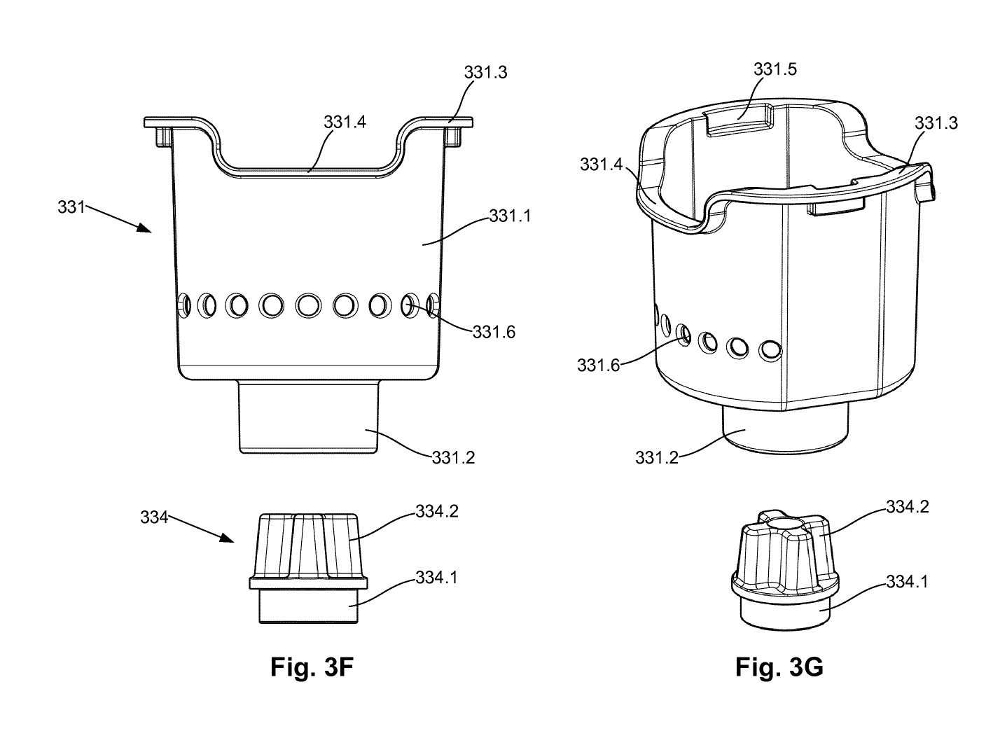

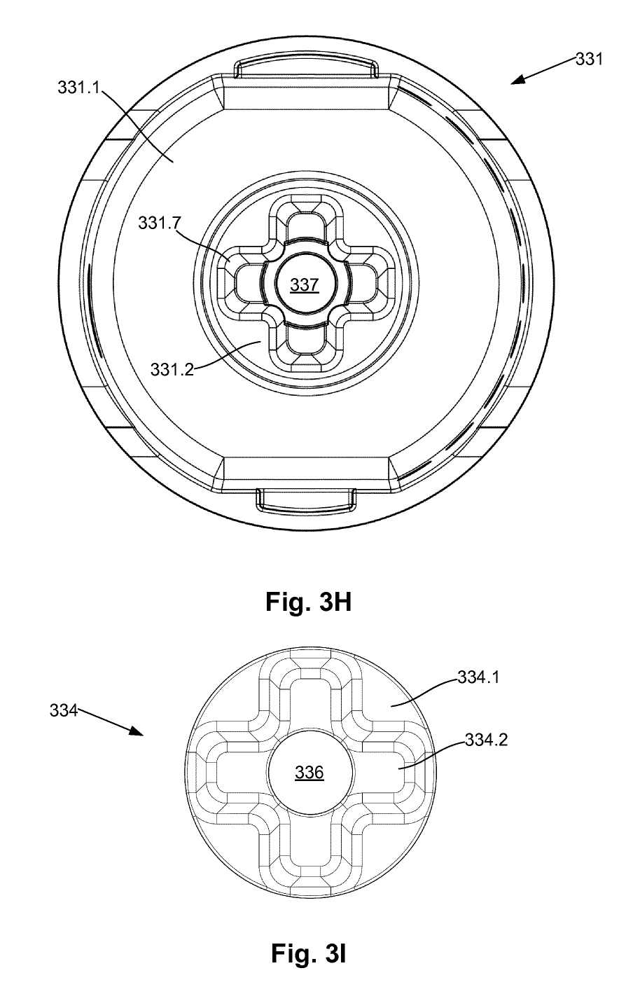

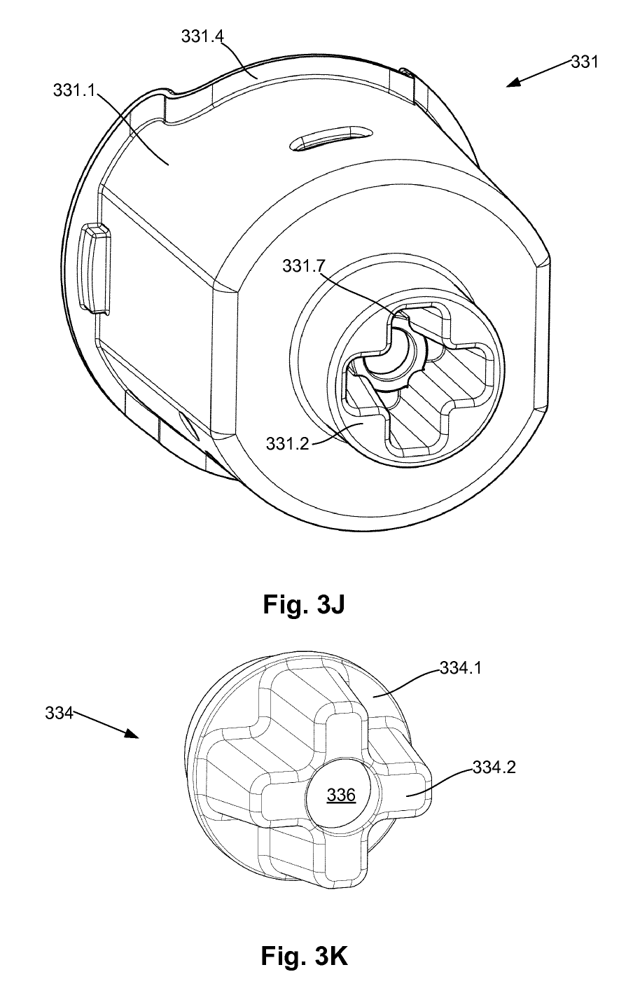

FIG. 5A is a schematic perspective view of a specific example of a capsule for use with the apparatus of FIG. 3;

FIG. 5B is a second schematic perspective view of the capsule of FIG. 5A with the lid removed;

FIG. 5C is a schematic cross sectional view of the capsule of FIG. 5A;

FIG. 5D is a schematic perspective view of an example of an insert of the capsule of FIG. 5A;

FIG. 5E is a schematic perspective view of a second example of an insert of the capsule of FIG. 5A;

FIG. 5F is a schematic plan view of the capsule of FIG. 5A showing cross section planes A-A′ and B-B;

FIGS. 5G and 5H are schematic cross sectional views along the lines A-A′ and B-B′ respectively, prior to engagement with a receptacle base;

FIGS. 5I and 5J are schematic cross sectional views along the lines A-A′ and B-B′ respectively, at the point of engagement with a receptacle base;

FIGS. 5K and 5L are schematic cross sectional views along the lines A-A′ and B-B′ respectively, during engagement with a receptacle base;

FIGS. 5M and 5N are schematic cross sectional views along the lines A-A′ and B-B′ respectively, at full engagement with a receptacle base;

FIGS. 50 and 5P are schematic view of a capsule showing data encoded on the capsule;

FIG. 6A is a schematic side view of a second specific example of an apparatus for dispensing beverage;

FIG. 6B is a schematic side view of the apparatus in FIG. 6A with a mounted bottle in a raised position;

FIG. 6C is a schematic side view of the apparatus in FIG. 6A with a mounted bottle in a lowered position;

FIG. 7A is a schematic diagram of an example of the fluid supply system;

FIGS. 7B to 7D are schematic diagrams of the operation of the fluid supply system of FIG. 7A;

FIGS. 7E to 7G are schematic diagrams of the operation of a second example of a fluid supply system;

FIG. 7H is a schematic diagrams of a third example of a fluid supply system;

FIG. 8A is a schematic side view of an example of a steriliser accessory;

FIG. 8B is a schematic perspective view of the steriliser accessory of FIG. 8A;

FIG. 8C is a schematic perspective exploded view of the steriliser accessory of FIG. 8A;

FIG. 8D is a schematic cross sectional view of the steriliser accessory of FIG. 8A;

FIG. 9A is a schematic side view of a second example of a beverage receptacle;

FIG. 9B is a schematic perspective view of the beverage receptacle of FIG. 9A;

FIG. 9C is a schematic cut away side view of the beverage receptacle of FIG. 9A;

FIG. 9D is a schematic perspective underside view of the beverage receptacle of FIG. 9A;

FIG. 9E is a schematic perspective view of an example of a base of the beverage receptacle of FIG. 9A;

FIG. 9F is a schematic perspective underside view of the base of FIG. 9E;

FIG. 9G is a schematic perspective view of a sealing member;

FIG. 9H is a schematic side view of the sealing member of FIG. 9G;

FIG. 9I is a schematic perspective view of the base of FIG. 9E with the sealing member of FIG. 9G removed;

FIG. 9J is a schematic plan view of the base of FIG. 9I;

FIG. 10A is a schematic plan view of a second example of a capsule;

FIG. 10B is a schematic perspective view of the capsule of FIG. 10A;

FIG. 10C is a schematic side view of the capsule of FIG. 10A;

FIG. 10D is a schematic side view of a third example of a capsule;

FIG. 10E is a first schematic perspective view of the paddle of the capsule of FIG. 10A;

FIG. 10F is a second schematic perspective view of the paddle of FIG. 10E;

FIG. 10G is a schematic side view of the paddle of FIG. 10E;

FIG. 10H is a schematic side view of the paddle of the capsule of FIG. 10E;

FIG. 10I is a schematic underside view of the paddle of the capsule FIG. 10E;

FIG. 11A is a schematic side view of a second example of a capsule holder including the capsule of FIG. 10A;

FIG. 11B is a schematic perspective view of the capsule holder of FIG. 11A;

FIG. 11C is a schematic perspective underside view of the capsule holder of FIG. 11C;

FIG. 11D is a schematic side cut away view of the capsule holder of FIG. 11A;

FIG. 12A is a schematic perspective view of a fourth example of a capsule;

FIG. 12B is a schematic perspective view of the lid of the capsule of FIG. 12A;

FIG. 12C is a schematic perspective underside view of the lid of FIG. 12B;

FIG. 12D is a schematic perspective view of the capsule body of FIG. 12A;

FIG. 13A is a schematic perspective view of a fifth example of a capsule;

FIG. 13B is a schematic plan view of the capsule of FIG. 13A with the lid removed;

FIG. 13C is a schematic perspective side view of the conduit body of the capsule of FIG. 13A;

FIG. 13D is a schematic underside view of the conduit body of FIG. 13C;

FIG. 14A is a schematic perspective underside view of a filter housing;

FIG. 14B is a schematic perspective top side view of the filter housing of FIG. 14A;

FIG. 14C is a schematic side cross section view of the filter housing of FIG. 14A incorporated into a cartridge holder;

FIG. 15A is a schematic perspective view of plates for use in a fluid supply system; and,

FIG. 15B is a schematic perspective view of a fluid supply system incorporating the water supply plates of FIG. 15A.

### DETAILED DESCRIPTION OF THE PREFERRED EMBODIMENTS

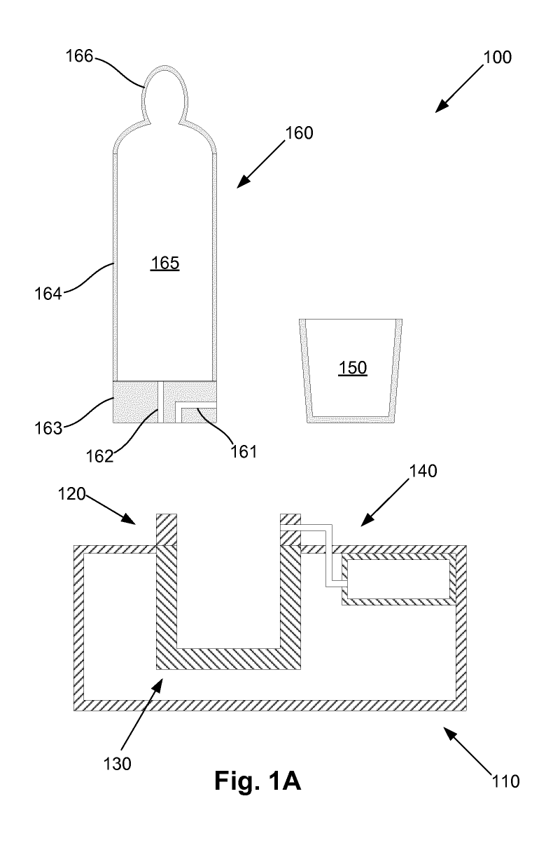

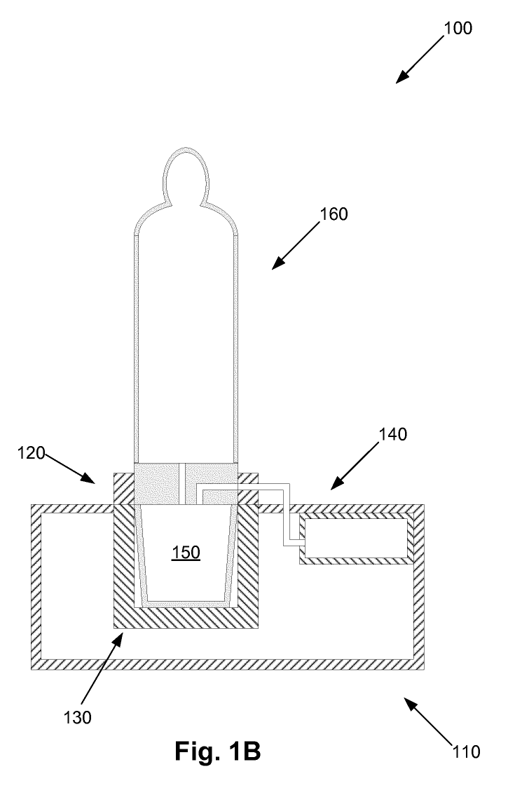

An example of an apparatus for dispensing a beverage will now be described with reference to FIGS. 1A and 1B.

In this example, the dispensing apparatus 100 includes an optional housing 110, a mounting 120, a capsule holder 130 and a fluid supply system 140. In use, the capsule holder 130 receives a capsule 150 containing a concentrated beverage, whilst the mounting 120 receives a receptacle 160, such as a nursing bottle, including first and second fluid conduits 161, 162, as shown in FIG. 1B. The fluid supply 140, selectively supplies fluid to the capsule 150 via the first conduit 161, to thereby form a liquid beverage from the beverage concentrate and supply liquid beverage to the receptacle 160, via the second conduit 162.

The capsule 150 typically includes at least one capsule side wall 151, a capsule base 152 and a pierceable capsule lid 153 defining a capsule cavity 154, which contains the concentrated beverage, although other arrangements may be used. The capsule side walls and base 151, 152 can be made of any suitable material, such as a thin plastic, or the like, whilst the capsule lid 153 can be made of a single or multi-layer film that can be pierced, ruptured or removed to access the contents.

The concentrated beverage may be in liquid, powder or any other available form, and typically includes a quantity corresponding to a single dose of liquid beverage, so that the capsules can be provided as single use capsules. The nature of the beverage will depend upon the particular application. In the current application in which the receptacle is a nursing bottle, the beverage concentrate is typically a powdered infant formula, which when diluted with a suitable quantity of water results in a single dose of liquid infant formula. However, it will be appreciated that the techniques can be applied to any suitable beverage, such as teas, coffees, medicated formulations, or nutritional drinks, including pregnancy drinks, breast feeding formulations, isotonic drinks, nutritional drinks for elderly people, or the like, and reference to infant formula is not intended to be limiting. Additionally, the beverage can be formed through a variety of processes, including diluting, reconstituting, infusing, or the like, and reference to diluting is not intended to be limiting.

The receptacle 160 can be of any suitable form and would typically include a receptacle base 163 containing the first and second fluid conduits 161, 162, a receptacle body 164 defining a receptacle cavity 165 for receiving the liquid beverage, and an opening, which may be covered with a lid having an aperture, for allowing the beverage to be consumed from the receptacle cavity 165. In the current example, in which the receptacle 160 is a nursing bottle, the opening includes a drinking teat 166, and it will be appreciated that in this instance, the nursing bottle can be of a similar form to existing nursing bottles, albeit with a modified base 163. However, other receptacles, such as cup, travel mugs, or the like, could also be used.

Additionally, in alternative examples, the receptacles 160 can be replaced with, or interchanged with, accessories that can be used for other functions other than dispensing a beverage, such as sterilising articles, mixing, steaming or blending food, or the like, as will be described in more detail below.

In use, liquid beverage can be produced by simply inserting a capsule 150 into the capsule holder 130 and providing the receptacle 160 in the mounting 120. The fluid supply 140 is then used to supply a fluid, such as water, into the capsule 150, allowing beverage to be dispensed.

In one example, this process is typically performed by selectively supplying fluid at first and second temperatures, so that for example hot water can be used to ensure the beverage is entirely dissolved, or brewed in the case of tea, before cold or unheated water is optionally supplied to form liquid beverage having a desired concentration and temperature. Additionally, by supplying the hot water at a suitable temperature, such as at least 70° C., or even up to 90° C. or above, this can assist in ensuring any bacteria within the concentrate are killed, thereby helping ensure sterility of the resulting beverage. The cold water can be at room temperature, or optionally chilled to below room temperature, depending on the implementation. The liquid beverage can be dispensed solely through the delivery of the hot and/or cold water, although additionally gaseous fluids, such as steam or air may be provided into the capsule 150 to purge the capsule and complete filling of the receptacle 160.

By providing fluid conduits in the base 163 of the receptacle 160, this allows fluid to be supplied to and received from the capsule via the pierceable lid, which may be pierced using spikes, fluid pressure, or any other appropriate mechanism, whilst the receptacle 160 is filled via the base 163. This provides a “bottom-up” filling approach in which the receptacle 160 is filled from the base 163 upwards. This minimises the size of housing 110 required, for example by avoiding the need to accommodate the entire receptacle 160 within the dispensing apparatus 100 as occurs in traditional “top-down” arrangements, allowing the dispensing apparatus 100 to be provided as a more portable device.

In the case of dispensing infant formula into a nursing bottle, the teat can be attached to the receptacle 160 in advance of filling and once the formula is dispensed to the receptacle, the infant may be fed directly without further manipulation of the bottle being required.

A further benefit of the arrangement is that the beverage is only ever in contact with the capsule 150 and receptacle 160, minimising sterilisation requirements for the dispensing apparatus 100. Furthermore, transferring of fluid to and from the capsule, only ever occurs via the lid, which in use is provided in an upward facing orientation, thereby minimising the chance of leaks and spillage. Furthermore, the ability to access the concentrate is limited as the capsule can be inserted into the dispensing apparatus 100 in a sealed configuration, thereby ensuring that beverage quality is maintained.

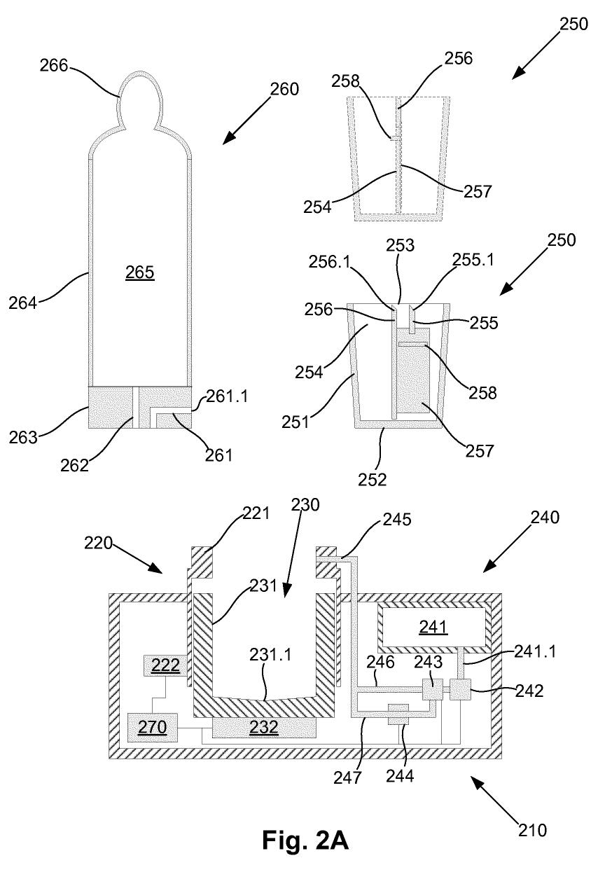

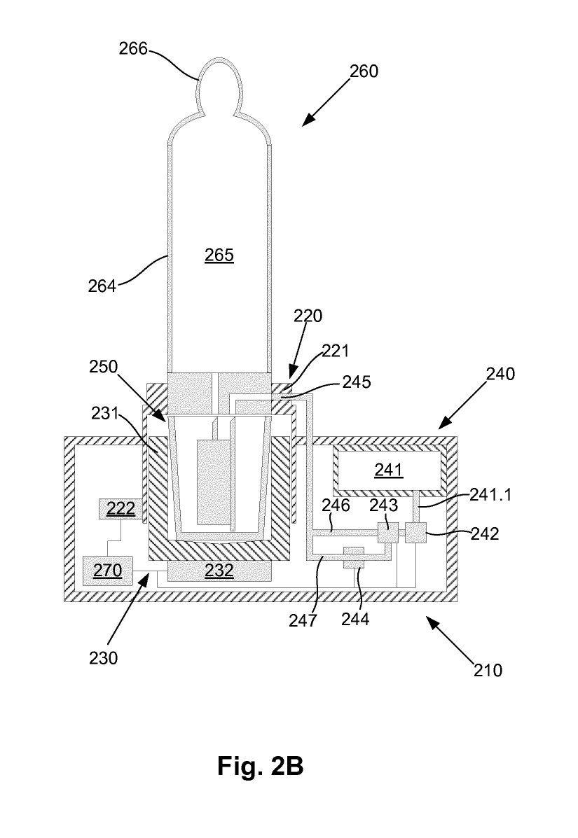

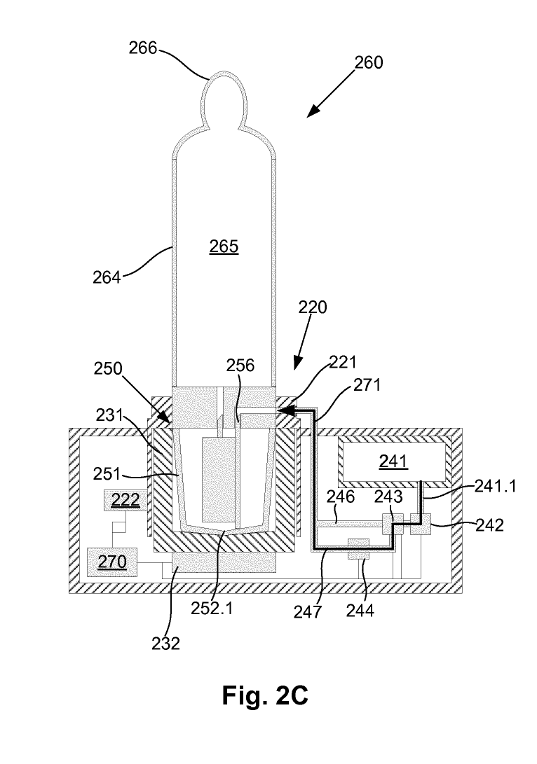

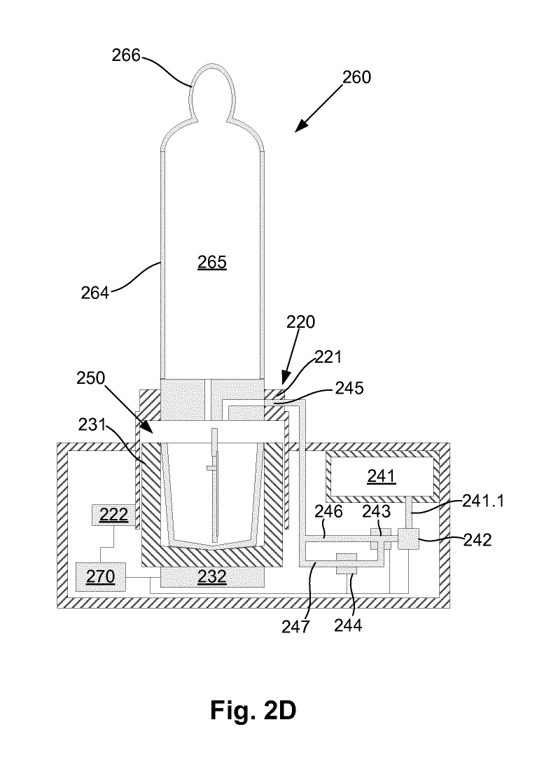

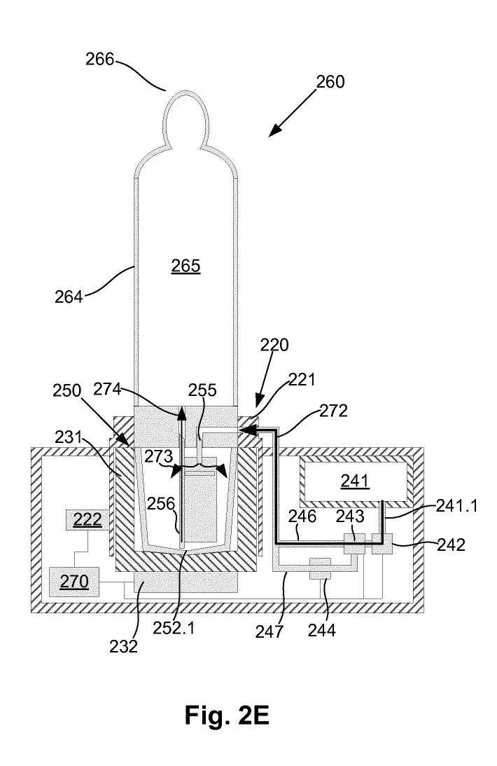

A second example, apparatus for dispensing beverage will now be described with reference to FIGS. 2A to 2E. In this example, similar reference numerals increased by 100 are used to denote similar features to the example of FIGS. 1A and 1B.

In this example, the mounting 220 is movably mounted to the housing 210 allowing the receptacle 260 to be selectively moved into engagement with the capsule 250. This can be achieved using a variety of arrangements, and in one example, the mounting 220 includes a generally cylindrical shaped mounting body 221 that is movably mounted to the housing 210. A mounting drive 222, such as a worm drive motor, is coupled to the mounting body 221, so that in use, the mounting body 221 can be moved between capsule engaging and capsule disengaging positions, as will be described in more detail below.

However, it will be appreciated that in alternative examples, movement may not be required, for example if the receptacle 260 engages the capsule 250 during coupling of the receptacle 260 to the mounting 220.

The receptacle 260 typically mechanically connects to the mounting 220, for example through the use of an interference fit, friction fit, clip fit, bayonet coupling or the like, with the mounting body 221. This can assist in providing a stable structure which will not be easily knocked-over and ensuring appropriate engagement between the receptacle 260 and capsule 250. The mechanical connection can also be used to align the receptacle 260 within the mounting 220, to thereby ensure correct alignment of the receptacle 260 and capsule 250, in use. In this regard, the mounting 220 can also include a sensor (not shown) for sensing engagement of the receptacle 260 and mounting 220, to prevent the apparatus operating if the receptacle is not present or correctly installed, thereby preventing incorrect functioning of the apparatus 200.

The capsule holder 230 is typically movably mounted to the housing 210 so that the capsule can be agitated, which assists in ensuring complete mixing of the concentrated beverage and fluid delivered into the capsule. In one example, the capsule holder 230 includes a closed ended generally cylindrical cup 231 for receiving the capsule 250, and a capsule holder drive 232 that at least partially rotates the cup 231 in a reciprocating manner to thereby agitate contents of the capsule 250, such as any fluid, beverage concentrate, or the like. The capsule holder drive 232 may be of any appropriate form, and can include a controllable stepper motor, or motor and crank system, to allow rotational movement to be converted into reciprocating rotational movement. To assist in ensuring rotation is translated to the capsule 250, the capsule 250 and cup 231 can be shaped to cooperate so as to prevent relative rotational movement of the capsule 250 relative to the capsule holder 230, as will be described in more detail below.

The capsule holder 230 may also include a capsule sensor (not shown) for sensing whether a capsule has been correctly inserted into the capsule holder, allowing operation to be halted in the event of incorrect insertion. Additionally, or alternatively, the capsule sensor could be used to detect a type of beverage being dispensed, allowing the delivery of fluid into the capsule to be controlled accordingly, for example by controlling the volume and/or temperature of fluid being delivered, as will be described in more detail below.

The cup 231 may include a concave depression 231.1 in a cup base, for assisting in guide deformation of the capsule base 252, as will be described in more detail below.

In this example, the capsule 250 includes first and second capsule conduits 255, 256 that in use selectively coupled to the first and second conduits 261, 262 when the receptacle 260 is in engagement with the capsule 250. This allows the fluid to be supplied into the capsule 250 via the first and/or second capsule conduit 255, 256, and liquid beverage to be dispensed from the capsule 250 via the second capsule conduit 256.

The first and second capsule conduits 255, 256 are generally parallel and spaced apart about a central axis of the capsule 250, so that if the capsule is rotated 180°, the first and second capsule conduits 255, 256 swap position. This allows the first and second capsule conduits 255, 256 to be provided in fluid communication with the second and first fluid conduits 262, 261, for example during supply of heated fluid, or in fluid communication with the first and second fluid conduits 261, 262, for example during supply of unheated fluid or steam.

The first capsule conduit 255 is typically shorter than the second capsule conduit 256, and terminates nearer the capsule lid 253 than the capsule base 252, whereas the second capsule conduit 256 extends substantially along a length of the capsule 250, and terminates adjacent the capsule base 252. However, it will be appreciated that other arrangements could be used, such as providing the first and second capsule conduits as respective channels within a common conduit or tube.

The first and second capsule conduits 255, 256 typically include respective spikes 255.1, 256.1, formed from an angled end of the capsule conduits 255, 256. In use, the spikes 255.1, 256.1 pierce the capsule lid 253, allowing the first and second capsule conduits 255, 256 to engage the first and second conduits 261, 262. To achieve this, the capsule 250 can be at least partially deformable, for example by having capsule side walls 251 deform, so that when the capsule 250 and receptacle 260 engage, the capsule lid 253 moves towards the capsule base 252 and the spikes 255.1, 256.1 pierce the capsule lid 253. However, it will be appreciated that alternative arrangements could be used, for example to provide spikes on the first and second conduits 261, 262.

In one example, at least part of the capsule base 252 deforms, due either to pressure in the capsule 250, or engagement of the base 252 and the second capsule conduit 256, so that a portion of the base adjacent the second capsule conduit 256 is offset from other portions of the base to thereby form a depression 252.1 adjacent the second capsule conduit 256, as will be described in more detail below. Engagement of the second capsule conduit 256 with the capsule base 253 can also assist in urging the first and second capsule conduits 255, 256 through the capsule lid 254. However, it will be appreciated that this is not essential.

The capsule 250 also includes a paddle 257 for agitating beverage within the capsule cavity 254, with the paddle typically being mounted to at least the second capsule conduit 256. In this example, the first capsule conduit 255 is also coupled to the paddle 257 and terminates offset from the capsule base 252, adjacent a baffle 258, which acts to direct fluid entering the capsule 250. It will be appreciated from this, that the first and second capsule conduits 255, 256, the paddle 257 and baffle 258 can be formed as a common insert (also referred to as a “conduit body”) into the capsule, and need not be discrete separate components.

As mentioned above, the receptacle 260 is similar in form to existing receptacles, and therefore includes a receptacle base 263, receptacle body 264 defining a receptacle cavity 265 for receiving the beverage, and an opening, in this case including a lid in the form of a teat 266. The receptacle base 263 is modified compared to traditional receptacle bases and includes the first and second conduits 261, 262. Accordingly the receptacle 260 can be made of any suitable material, and made in any suitable manner, such as by connecting individual components or creating an integral receptacle, as will be appreciated by persons skilled in the art.

The second fluid conduit 262 typically includes a one way valve (not shown) to prevent fluid flow from the receptacle 260 to the capsule 250, with the one way valve being opened either by engagement with the second capsule conduit 256 of the capsule 250, as a result of fluid pressure in the second capsule conduit 256, or a pressure differential between the receptacle cavity 265 and the second fluid conduit 262. The one way valve can be of any suitable form, and in one example is a duck-bill valve, diaphragm valve, flap valve or the like. In one example, the valve 267 is mounted in a base plate between the receptacle base 263 and an opening in the receptacle body 264, in which case the base plate can include a channel defining at least part of the first fluid conduit 261, as will be described in more detail below.

In this example, the fluid supply system 240 includes a reservoir 241, containing a fluid, typically water, for diluting or infusing the concentrated beverage. The reservoir 241 may be removed for filling or filled in-situ, for example via a suitable opening. The reservoir 241 is connected to a pump 242 that receives fluid from the reservoir 241 and pumps this to a flow control valve 243. The flow control valve 243 transfers the fluid to either cold or hot fluid conduits 246, 247, which are in turn connected to an outlet port 245. The outlet port 245 is coupled to the mounting body 221, thereby allowing fluid to be provided to the first conduit 261 via a first conduit inlet 261.1 provided in an outer circumferentially perimeter surface of the base 263. A heater 244 is provided in thermal communication with the hot fluid conduit 247, allowing cold or heated water to be delivered to the capsule 250, depending on the particular setting of the flow control valve 243.

The fluid supply system 240 can incorporate a filter, such as an anti-microbial filter, to assist in maintaining the quality of fluid delivered to the receptacle 260, although alternatively this could be incorporated into the capsule 250. If provided as part of the fluid supply system 240, the filter is typically removably mounted within the housing 210, allowing this to be periodically replaced or reconditioned, as required. The fluid supply system 240 can also be adapted to generate steam for sterilising the dispensing apparatus 200, or receptacle 260, or purging the capsule 250, as will be described in more detail below.

Typically operation of the apparatus is controlled at least in part using a controller 270, which can control one or more of the fluid supply 240, the mounting 220 and the capsule holder 230, for example to selectively supply fluid to the capsule 250, to move the receptacle 260 relative to the capsule 250, or to move the capsule holder 230 to agitate the capsule 250.

To achieve this, the controller 270 is typically coupled to the mounting drive 222, the capsule holder drive 232, the pump 242, the flow control valve 243 and the heater 244. The controller 270 may also optionally be coupled to one or more sensors (not shown) for sensing operation of the apparatus 200, such as the temperature or volume of fluid supplied to the capsule 250, the presence, absence or type of capsule 250, or the presence, absence or type of receptacle 260.

In the case of making infant formula, the controller 270, causes the fluid supply system 240 to supply heated fluid into the capsule 250 to thereby form slurry from the beverage concentrate. However, when producing other drinks such as tea, this may involve infusing leaves to form the liquid beverage, in which case, slurry may not result.

The controller 270 then moves the capsule holder 230 to thereby agitate the slurry, or other contents, before using the fluid supply system 240 to supply unheated fluid into the capsule to thereby urge diluted infant formula into the receptacle 260. In particular, as the capsule 250 fills, the pressure rises until the liquid beverage is forced upwards via the second capsule conduit 256, through the second conduit 256 and one-way valve, and into the receptacle 260. The controller 270 may also cause the fluid supply system to supply steam or air into the capsule 250 to thereby purge the capsule and optionally sterilise the apparatus. Air or steam may also be delivered into the capsule at other stages, such as between delivery of hot and cold water, for example to purge the fluid conduits.

The controller 270 is typically any form of electronic control system that is capable of generating control signals for controlling the drives 222, 232, and fluid supply system 240. In one example, the controller 270 can be any form of electronic processing device such as a microprocessor, microchip processor, logic gate configuration, firmware optionally associated with implementing logic such as an FPGA (Field Programmable Gate Array), or any other electronic device, system or arrangement capable of generating control signals and optionally receiving and interpreting signals from any sensors. The controller 270 may also include other components such as a memory, an input/output (I/O) device, such as input buttons and/or display, or the like. The controller 270 may also include an optional external interface for allowing connection to remote devices, such as computer systems or the like, to allow the apparatus 200 to be maintained, updated, or controlled.

Example operation of the apparatus 200 will now be described in more detail.

In this example, the user initially provides the apparatus in a load configuration shown in FIG. 2B by inserting a capsule 250 into the cup 231, and positioning the receptacle 260 in the mounting body 221. In this regard, the cup 231 and capsule have complimentary shapes to ensure the capsule 250 is mounted within the cup 231 in a desired orientation. Similarly, the receptacle base 263 and mounting body 221 are configured to ensure the receptacle 260 is correctly orientated both with respect to the capsule 250 and the housing 210, thereby ensuring the fluid conduits 261, 262 correctly couple to the capsule 250 and the fluid supply system 240.

The user then activates the controller 270, for example by pushing an input button (not shown). The electronic processing device of the controller 270 typically executes instructions stored in the memory, allowing the apparatus 200 to be controlled in accordance with a predetermined set of operating instructions. For example, the controller 270 could be adapted to prepare a different volume or temperature of the beverage, depending on particular parameters stored in memory. One example of this is in the case of different ages of infant, in which feed amount requirements and particular formula used may vary. Similarly, different beverages will typically have different water supply and/or mixing requirements. Accordingly, the controller 270 can store different parameters, allowing beverages to be dispensed differently for specific requirements.

In one example, the user may be required to select a predetermined operation, such as preparation of a particular beverage, allowing the controller 270 to automatically determine the parameters. Alternatively, the user may specify or override parameters using appropriate inputs, for example to manually control the volume, dose and/or temperature of the dispensed beverage.

In a further example, the controller 270 can be coupled to a sensor for sensing coded data, such as a barcode or the like, provided on the capsule 250. In this example, when beverage is to be prepared, the coded data is sensed, for example during or following insertion of the capsule 250 into the capsule holder 230. The controller 270 then uses the coded data to determine operating parameters, for example by retrieving parameters from memory or decoding these from the coded data.

In a further example, the controller 270 can also be adapted to operate the apparatus 200 to function with other accessories, such as a steriliser, food warmer, food steamer, drink maker, sterile water dispenser, beaker, blender, food mixer, milkshake maker, or the like. These accessories can be adapted to be coupled to the mounting, allowing steam and/or heated fluid to be supplied thereto as required. Additionally, in the case of a food mixer, the mixer may include blades mounted on a shaft that is driven by the capsule holder drive 232, in use, as will be described in more detail below.

Accordingly, the controller 270 can be coupled to a sensor for sensing the type of receptacle 260 and/or accessory mounted to the apparatus. In this regard, coded data could be used, such as a barcode or the like, provided on the receptacle 260 or receptacle base 263. However, alternative mechanism, such as the use of RFID (Radio Frequency Identification) tags mounted on the receptacle 260 or accessory, and a correspondence detector in the housing 210. In this example, controller 270 uses an indication of the sensed receptacle 260 or other accessory to control the operation of the apparatus, based on determined operating parameters.

In any event, it will be appreciated that the controller 270 can automatically control the temperature and volume of the fluid delivered, the mixing time or extent, or any other parameters associated with the process, ensuring the beverage is appropriately prepared and optionally, that other accessories are operated correctly.

In one example, once activated, the controller 270 optionally senses whether the capsule 250 and receptacle 260 have been mounted correctly, and if not can provided an error indication, via an appropriate output, such as an LED (Light Emitting Diode) or the like, allowing the user to correct the capsule and/or receptacle placement. The controller 270 may also determine operating parameters either based on user inputs and/or sensing of the capsule 250 and/or receptacle 260. In one example, this is achieved by sensing data printed on the capsule side walls 251 during rotation of the capsule 250, as will be described in more detail below.

Once correctly positioned, the controller 270 activates the mounting drive 222, thereby lowering the mounting body 221 into a filling configuration shown in FIG. 2C. In this example, the mounting body 221 is lowered towards the capsule 250, however it will be appreciated that in an alternative arrangement, the capsule holder 230 could be raised towards the receptacle 260, although in general this would be more complex as it would require that the capsule holder drive accommodate the movement.

During this process, the receptacle 260 moves into engagement with the capsule 250, thereby causing deformation of at least the capsule side walls 251 so that the spikes on the first and second capsule conduits 255, 256 pierce the capsule lid 253 and engage the second and first fluid conduits 262, 261 in the receptacle base 263, respectively. The capsule base 252 may also deform, for example due to movement of the second capsule conduit 256 towards the capsule base 252, or due to an increase in pressure within the capsule 250. This causes a portion 252.1 of the capsule base 252 adjacent the second capsule conduit 256 to be offset from than other portions of the base 252, defining a concave depression adjacent the second capsule conduit 256, so that fluid pools in the bottom of the capsule 250 adjacent the second capsule conduit 256.

Next, the controller 270 activates the pump 242, the flow control valve 243 and heater 244 so that heated fluid is supplied to the capsule 250, via the hot fluid conduit 247, the outlet port 245, the first fluid conduit 261, and second capsule conduit 256, as shown by the arrow 271. In this case of infant formulas, as the heated fluid mixes with the infant formula concentrate, infant formula slurry is formed. The temperature and volume of the fluid may be set so as to facilitate this process, and may therefore depend on factors such as the nature of the infant formula concentrate. In one example, the fluid is heated to at least 70° C., and more optionally at least 90°, although other temperatures may be used, depending on the particular operating parameters.

As the heated fluid enters the capsule through the second capsule conduit 256, excess pressure may be vented into the receptacle 260, via the first capsule conduit 255 and second fluid conduit 262.

After the heated fluid has been supplied, the controller 270 causes the mounting body 221 to be raised into the mixing configuration shown in FIG. 2D. The capsule 250 is retained in the capsule holder 230 using any suitable technique such as friction between the capsule 250 and cup 231, by having a retaining clip, or the like. Alternatively, this could be caused by pressure in the capsule 250 urging the capsule 250 and receptacle 260 apart, so as the mounting body 221 is raised, the capsule 250 and receptacle 260 will disengage.

Once the receptacle 260 has been raised, the controller 270 activates the mounting drive 232, causing the cup 231 and hence the capsule 250 to be rotated in a reciprocating manner. This causes one or more paddles 257 to agitate the slurry made from the fluid and beverage concentrate, to thereby cause mixing and hence ensure even and complete dilution of the beverage concentrate.

The extent of rotation can vary depending on the beverage being formed. In one example this is between 40° and 320°, between 90° and 270°, and more typically between 180° and 270°. Additionally, rotation can be effected periodically, starting and stopping with a predetermined frequency, such as between 3 and 20 Hz and more typically 5 Hz. The use of reciprocating and/or periodic rotational movement in combination with a paddle 257 is particularly advantageous as reversal of motion causes additional agitation to enhance mixing. It will also be appreciated that the use of the stepper motor allows the capsule to be rotated in angular increments, such as 18° increments, dependant on the motor configuration.

It will also be appreciated that with some beverages mixing may not be required, and reference to mixing is not therefore intended to be limiting.

After mixing for a predetermined amount of time determined from parameter stored in memory, the controller 270 realigns the capsule 250 and receptacle 260, in this example, with the first and second capsule conduits 255, 256 aligned with the first and second conduits 261, 262 and lowers the mounting body 221, to provide the apparatus in a dispensing configuration shown in FIG. 2E. It will be appreciated that in this configuration, the capsule 250 is rotated 180° relative to when the capsule 250 is in the filling configuration shown in FIG. 2C.

During this process, the controller 270 may optionally monitor sensors to ensure the capsule 250 and receptacle 260 are correctly aligned, with the process being halted in the event that a misalignment is detected.

At this point, the controller activates the pump 242 and flow control valve 243 to cause unheated fluid to be supplied to the first capsule conduit 255 via the cold fluid conduit 246, as shown by the arrow 272. As fluid enters the capsule, it impinges on the baffle 258 and is deflected outwardly from a centre of the capsule 250, as shown by the arrows 273. This helps ensure even mixing of the fluid and beverage concentrate. As the capsule 250 fills with fluid, diluted beverage is urged through the second capsule conduit 256 and into the receptacle 260, as shown by the arrow 274.

Following this, the controller 270 can adjust the flow control valve 243 and activate the heater 244, to cause steam to be dispensed into the capsule 250, via the hot fluid conduit 247. The steam pressure acts to purge the capsule 250, urging any remaining beverage into the receptacle 260 via the second capsule conduit 256. In this regard, it will be appreciated that the deformed base portion 252.1 of the capsule 250 causes fluid to pool near the second capsule conduit 256, whilst steam is urged outwardly by the baffle 258. This prevents uneven and excessive heating of any of the remaining formula, whilst maximising the amount of formula that is dispensed from the capsule 250. This is important in ensuring the correct dose is delivered, and to prevent formula left in capsules from spoiling and creating a health hazard. This process further operates to sterilise the equipment, as will be described in more detail below.

The controller 270 can also be adapted to record information derived from signals from any sensors, such as information regarding fluid temperatures and flows, operation performed, receptacle used, and/or drink type dispensed, as well as any fault conditions, such as problems in alignment of receptacle 260 and capsule 250, or in mounting the receptacle 260. This can be used for example to provide a log of operations, which can assist in identification of faults, or misuse, as well as to monitor usage of any filter. In one example, the time for which the filter has been used, or fitted to the apparatus 200, or the amount of water flowing through the filter, or number of times the filter is used can allow the controller to determine when the filter needs to be replaced. In the event that the filter requires replacement, the controller 270 can generate an indication, such as displaying a filter replace indication, and/or halt operation of the apparatus.

A specific example of an apparatus for dispensing beverage will now be described with reference to FIGS. 3A and 3B.

In this example the apparatus 300, includes a housing 310 including a lower housing portion 311 and an upper housing portion 312 defining a reservoir 341. The lower housing portion 311 includes a mounting support 313, capsule holder drive support 314 and a cup support 315, which are utilised for supporting the mounting 320 and capsule holder 330. The housing 310 and supports 313, 314, 315 can be made of any appropriate materials, such as plastics, including but not limited to polyvinylchloride, polyethylene, polypropylene and polycarbonate, and can be integrally formed or made of separate interconnected components, depending on the preferred implementation.

The apparatus 300 includes a mounting body 321, in the form of a generally cylindrical tubular plastic body. The mounting body 321 may also include a rubber ring for engaging the base 363 of the receptacle 360 to assist retain the receptacle 360 in position.

This may further provide a sealing function to prevent egress of liquids, for example in the event that the capsule 350 and receptacle 360 fail to engage correctly.

The receptacle 360 is also typically secured so as to ensure the receptacle base 363 is held in a particular orientation, thereby aligning the first and second conduits 361 with the first and second capsule conduits 355, 356 of the capsule, and with an outlet port 345 of the fluid supply system. In one particular example, this can be achieved through a bayonet coupling and/or engagement of the outlet port 345 with the base 363.

In one example, the mounting body 321 is configured as shown in FIGS. 3C to 3E, to include a generally annular wall 321.1, which in use receives the receptacle base 363. The annular wall 321.1 includes four circumferentially spaced mounting flanges 321.2 extending radially inwardly from an inner surface of the wall 321.1, which in use engage corresponding base flanges extending outwardly from the receptacle base 363, as will be described in more detail below, thereby retaining the receptacle base 363 in a desired position and orientation, in use.

The mounting body 321 also includes an outlet port housing 321.3, extending upwardly from the annular wall 321.1. The outlet port 345 may be movably mounted within the outlet port housing 321.3, allowing the outlet port 345 to be urged into sealing engagement with the first conduit, for example, by biasing the outlet port 345 into sealing engagement with an inlet of the first conduit using a spring or the like, or by actively moving the outlet port during movement of the mounting body 321. This can be used to ensure effective transfer of fluid to the first conduit.

The mounting body 321 may also include a number of sensors, such as micro-switches, provided at specific locations on or adjacent to the annular wall 321.1. In one example, the micro-switches are adapted to engage shaped portions of the receptacle base, so that the micro-switches are selectively actuated depending on the configuration of the receptacle base. This can be used to allow different configurations of receptacle base to be encoded using different shapes, so that each configuration actuates a respective combination of micro-switches, thereby allowing the controller to ascertain a receptacle type, such as whether the receptacle is a cup, bottle or the like. This can also be used to ensure that the receptacle is fitted to the mounting 321, and in particular that the receptacle is correctly orientated and mechanically coupled to the mounting 321.

The mounting body 321 extends into the housing 310 radially inwardly of the mounting support 313, and includes teeth 323 extending circumferentially around an outer surface of the body 321. The teeth 323 engage a correspondingly toothed annular gear 324 extending circumferentially around the outer surface of the mounting body 321, which is supported in a recess of the mounting support 313. The gear 324 is coupled to the mounting drive 322 via a worm gear (not shown), so that the gear 324 can be rotated, thereby causing the mounting body 321 to be raised, as shown in FIG. 3A and lowered, as shown in FIG. 3B as required.

The capsule holder 330 includes a capsule holder drive stepper motor 332 coupled via a drive shaft 333 to a spindle 334. The spindle 334 is rotatably supported by the cup support 315 via ball bearings 335 and is magnetically coupled to the cup 331 via magnets 336, 337 mounted in the spindle 334 and cup 331, respectively. This allows the cup 331 to be magnetically decoupled from the spindle 334, and removed from the housing 310, for example in the event that cleaning or maintenance is required. This can also be used to allow accessories to be magnetically coupled to the stepper motor 332 via the spindle 334, allowing blades or the like to be driven in use.

The cup 331 and spindle 334 are also typically mechanically coupled, as will now be described with reference to FIGS. 3F to 3K, which show the cup 331 and spindle 334 in more detail.

In this example, the cup 331, includes a cup body 331.1 having a socket 331.2 mounted on a base thereof. The spindle 334 includes a spindle body 334.1, which in use is mounted on the drive shaft 333, and a male hub 334.2. In use, the male hub 334.2 is mounted within the socket 331.2, which acts as a female hub 331.7 and has a complimentary shape to the male hub 334.1, so that torque can be transmitted from the spindle 334 to the cup 331. In this example, the male hub has a generally cross shaped configuration, but it will be appreciated that other arrangements can be used, and that reference to the cross shape is not intended to be limiting.

In any event, in this example, the male and female hubs are complimentary in shape allowing the male and female hubs to be rotationally coupled simply by positioning the male hub 334.2 within the socket 331.2. It will be appreciated that this allows the cup 331 to be mechanically coupled to the spindle 334, simply by placing the cup socket 331.2 on the spindle 334. Furthermore, the magnets 336, 337 can be provided on an end of the male hub 334.2 and within the socket 331.2, so that when the socket 331.2 engages the spindle 334, the cup and spindle are mechanically and magnetically coupled. This allows the cup and spindle to be easily connected and disconnected, allowing the cup 331 to be removed and replaced, or for example to allow accessories to connect to the spindle 334, whilst ensuring that torque is successfully transferred to the cup 331, in use.

The cup body 331.1 further includes a rim 331.3, extending around an upper edge of the cup body 331.1. The rim 331.3 includes two depressions 331.4 located on opposing sides of the rim 331.3, which are used to assist in deformation of the capsule, as well as recesses 331.5 to assist in aligning the capsule within the cup 331, as will be described in more detail below. The cup body 331.1 may also include one or more apertures or windows 331.5 circumferentially spaced around the cup body 331.1 to allow for reading of coded data, as will be described in more detail below.

The fluid supply system includes the reservoir 341, pump 342, a number of flow control valves 343, heater 344, the outlet port 345 and outlet port connecting pipe 346, which are interconnected using appropriate pipes or tubes (not shown for clarity). Example connectivity will be described in more detail below.

It will be appreciated that the apparatus 300 functions substantially similarly to the previous examples and will not therefore be described in any further detail.

A specific example of a receptacle will now be described with reference to FIGS. 4A to 4H. For the purpose of this example, the receptacle is assumed to be a nursing bottle, but it will be appreciated from the following description that the general features will apply to other receptacles, such as cups, travel mugs or the like.

In this example, the receptacle 460 includes a receptacle body 464 defining the receptacle cavity 465. The receptacle body 464 is open at a teat end and includes a teat mounting 464.1, to receive a teat (not shown). The teat may be held in place using any suitable technique, and in one example this is achieved using a teat cover ring (not shown) that engages the teat mounting 464.1, for example using a screw fit, interference fit, friction fit, clip fit, or the like. It will be appreciated that these components are substantially standard and are made of known materials suitable for use in nursing bottles, such as polycarbonate, polyvinylchloride, polypropylene, or the like. Additionally selected ones of the components could be integrally formed, such as the teat and teat cover, thereby minimising the assembly process.

In this example, the receptacle body 464 also includes a base mounting 464.2 defining an opening at a base end, which receives a receptacle base 463, which is typically made of rubber or the like, and which is coupled to the receptacle body 464, for example using a screw, clip, friction, interference fit or the like.

In this example, the receptacle base 463 includes a convex capsule engaging ridge 463.1 that projects from, and extends across a substantially planar base under-surface 463.2. A base rim 463.3 is provided extending perpendicularly from a perimeter of the base under-surface 463.2, the base rim 463.3 extending from the base under-surface 463.2 a distance greater than that of the capsule engaging ridge 463.1. Consequently, when the receptacle 460 is placed on a flat surface S in use, it is supported by the rim 463.3 with the capsule engaging ridge 463.1 held spaced from the relevant surface S. The circumference of the base rim 463.3 is greater than the perimeter of the capsule, so that the capsule can be received within the base rim 463.3, allowing the capsule to be deformed as will be described in more detail below.

The base rim 463.3 further supports base flanges 463.4 extending radially outwardly from, and circumferentially spaced apart about, an outer surface of the base rim 463.3. In use, the base flanges 463.4 engage with the mounting flanges 321.2 of the mounting body 321, allowing the receptacle base 463 to be mechanically engaged with the mounting body 321.

The base 463 includes the first conduit 461, including an inlet port 461.1 on an outer circumferential surface of the base 463 and an outlet port 461.2 terminating on the ridge 463.1. The second conduit 462 extends through the base from a second conduit inlet 462.1 provided on the ridge 463.1 and terminating in a one-way duckbill valve 467. The valve 467 would typically be closed, with the valve 467 being opened either through engagement of the second conduit 462 with the second capsule conduit of the capsule, by liquid pressure in the second conduit 462, or by a pressure differential between the second conduit 462 and the receptacle cavity 465.

In the current example, the second conduit 462 is angled so that the valve 467 is mounted substantially in the centre of the receptacle base 463, whilst the second conduit 462 inlet 462.1 is offset from the centre of the receptacle base 463. This allows the second conduit 462 to engage the first and second capsule conduits, as the capsule is rotated between filling and dispensing configurations, whilst providing the valve 467 in the centre of the base 463, to assist with easy fitting.

In use, the valve 467 allows fluid flow into the receptacle 460, via the receptacle base 463. The primary purpose of this is to allow a beverage to be provided into the receptacle 460, whilst preventing the beverage leaking from the receptacle 460 when the receptacle 460 is not being filled. However, additionally the valve 467 can be configured to allow air to enter the receptacle 460 while the beverage is being consumed, for example as a result of pressure differences between the receptacle cavity 465 and the ambient environment outside the receptacle 460, thereby helping to reduce colic induced during bottle feeding.

In the current example, the first and second conduits 461, 462 and the valve 467 can be formed from a base insert 468, which is a shaped rubber member that sits within the receptacle base to define the first and second conduits as shown in FIG. 4G.

However, as an alternative, the insert can be provided as a base plate, as will now be described with reference to FIGS. 4M to 4N. In this example the base plate 468 is urged against the opening at the base end 464.2 of the bottle body 464 by the base 463. The valve 467 is mounted in the base plate 468, with part of the first fluid conduit 461, being formed from a channel 461.3 in an underside of the base plate 468. The first fluid conduit 461 includes an inlet port 461.1 on an outer circumferential surface of the base 463 and an outlet port 461.2 terminating on the ridge 463.1. The second fluid conduit 462 extends through the base from a second conduit inlet 462.1 provided on the ridge 463.1 and terminating in a one-way duckbill valve 467. The valve 467 would typically be closed, with the valve 467 being opened either through engagement of the second conduit 462 with the second capsule conduit of the capsule, by liquid pressure in the second conduit 462, or by a pressure differential between the second conduit 462 and the receptacle cavity 465. Thus, it will be appreciated that operation of the receptacle is substantially as previously described.

In either case, when the receptacle 460 is mounted to a mounting, such as the mounting body 321, the receptacle 460 is initially positioned with the receptacle base 463 offset from the mounting body 321, aligned with the inner surface of the annular wall 321.1, and with the first conduit inlet 461.1, rotationally offset to the outlet port 345. The receptacle and hence receptacle base 463 is then urged towards the mounting body 321 in the direction of the arrow 491, until before the receptacle impinges on the mounting body 321, at which time the receptacle is rotated in the direction of arrow 492, until the outlet port 345 and first conduit inlet 461.1 are aligned. At this stage, the base flanges 463.4 are positioned beneath the mounting flanges 321.2, thereby correctly orientating and retaining the receptacle base in position.

A specific example of the capsule will now be described with reference to FIGS. 5A to 5D.

In this example, the capsule 550 includes capsule side walls 551, having a side wall rim 551.3, a capsule base 552 and a film lid 553, coupled to the side wall rim 551.3. The capsule side walls 551 include an indented portion 551.1, which in use engages a correspondingly shaped portion of the capsule holder to prevent relative rotation of the capsule 550 and capsule holder.

The capsule 550 also includes an insert including the first and second capsule conduits 555, 556 coupled to two paddles 557 and baffle 558. Arms 559 extend laterally and upwardly from the insert and include a shaped end 559.1 that engages an underside of the side wall rim 551.3 of the capsule 550 to thereby retain the insert in a desired position within the capsule 550. This shaping can also cooperate with recesses 331.5 in the capsule holder 330 to further assist orientate the capsule 550 relative to the capsule holder 330.

A filter, such as an antimicrobial filter, can be supported between the first capsule conduit 555 and baffle 558, or within the first or second conduits 555, 556, thereby filtering water as it is delivered into the capsule. However, this is not essential and the filter can alternatively be provided in the fluid supply system.

The insert may also further include a lid engaging plate 553.1 that engages an underside of the capsule lid 553 and the receptacle base to effect sealing between the capsule 550 and receptacle, when the capsule 550 and receptacle base 463 are engaged.

The paddles 557 extend laterally outwardly from the second capsule conduit 556 and are fixed relative to the insert and hence the capsule 550 so that rotation of the capsule 550 results in corresponding rotation of the paddles 557, thereby agitating fluid within the capsule. In one example, the paddles 557 include holes allowing fluid to flow therethrough, although this is not essential and a solid paddle can be used as shown in the example of FIG. 5E. Typically, the paddle takes up 30% to 80% of the vertical cross sectional area of the capsule 550 to assist in ensuring adequate mixing of fluid therein.

The capsule side walls, base, lid and insert 551, 552, 553 can be made of any suitable material, such as a thin plastic, or the like. In one example, the components of the capsule 550 are manufactured using thermoforming with an injection moulded insert and top foil sealing, with all of the materials in the packaging being made of a single material, such as polypropylene, which is resistant against temperatures above 60°.

FIG. 5F shows a plan view of the capsule 550 illustrating cross sectional planes that are used in FIGS. 5G to 5N, which show an example process of the capsule 550 engaging the receptacle base 463 of the receptacle 460 described in FIGS. 4A to 4H.

As shown the receptacle base 463 includes the capsule engaging ridge 463.1 projecting outwardly from and extending radially across the receptacle base 463. The first and second conduits 461, 462 terminate at an upmost point of the capsule engaging ridge 463.1.

As shown in FIGS. 5G and 5H, the receptacle base 463 is aligned with the capsule 550, so that the capsule engaging ridge 463.1 is provided above a central axis of the capsule 550, and so that the first and second conduits 461, 462 align with the second and first capsule conduits 556, 555, respectively. Additionally, the capsule 550 would be positioned within the cup 331, so that the capsule rim 551.3 rests on the cup rim 331.3, with the cup rim depressions 331.4, aligned with the capsule engaging ridge 463.1. The receptacle 460 is then urged downwards until the ridge 463.1 engages the lid 553 of the capsule 550, as shown in FIGS. 5I and 5J.

As the receptacle base 463 continues to move towards the capsule 550, the capsule side walls 551 deform beneath the ridge 463.1, as shown at 551.2, thereby applying a stretching force to the capsule lid 553 in the direction of the arrow F in FIGS. 5K and 5L. This controls tension in the lid 553, for example to prevent an over tension, thereby assisting spikes 555.1, 556.1 on the first and second capsule conduits 555, 556 pierce the film lid 553 before mating with the second and first conduits 462, 461 as shown in FIGS. 5M and 5N.

To assist with deformation of the capsule side walls 551, portions of the capsule side walls 551 and/or capsule side wall rim 551.3 can be adapted to deform in preference to other portions, for example by varying the thickness of the capsule side walls 551 and/or capsule side wall rim 551.3, that will be adjacent the ridge 463.1, in use. This allows the capsule lid 553 to deform with less force in the direction of the first and second capsule conduits 555, 556, thereby decreasing the piercing force required, and preventing the top foil from breaking at different spots other than designated. This process also releases the plane stress from the top foil, thereby ensuring that deformation occurs below the ridge 463.1 of the receptacle base 463.

Additionally, by aligning the cup rim depressions 331.4 with the capsule engaging ridge 463.1, this allows the capsule engaging ridge 463.1 to be accommodated within the depressions 331.4 to ensure deformation of the capsule is not impeded by the capsule holder 330.

As the receptacle base 463 fully engages the capsule 550, the capsule side walls 551 continue to deform, whilst a centre portion 552.1 of the capsule base 552 also deforms outwardly as a result of engagement with either the second capsule conduit 556 or paddles 557. This creates a depression 552.1 adjacent the second capsule conduit 556 so that fluid collects therein, maximising the chance of fluid being dispensed from the capsule as previously described.

The lid engaging plate 553.1 also engages an underside of the capsule lid 553 and the receptacle base flange 463.1, thereby sealing the capsule 550 against the receptacle base 463, to ensure effective fluid transfer between the first and second conduits 461, 462 and the first and second capsule conduits 555, 556.

An example of a data encoding technique for providing machine readable coded data indicative of the content of the capsule will now be described with reference to FIGS. 50 and 5P.

In this example, the capsule 550 includes a number of marking regions 581, 582 provided on the capsule sidewalls 551. The marking regions 581, 582 are generally circumferentially spaced around the outer surface of the capsule sidewalls 551 at a set height relative to the base 552, so that when the capsule 550 is positioned in a capsule holder, the marking regions 581, 582 align with windows 331.6, allowing the marking regions to be sensed through the windows using an optical sensor 580. The sensor may be of any appropriate type, but in one example, is a reflectance sensor, adapted to sense radiation reflected from the capsule surface through the windows. Accordingly, in this example, the optical sensor 580 typically illuminates the marking regions 581, 582, using a light source, such as a light-emitting diode (LED), and receives radiation reflected from the marking regions 581, 582, using a light sensitive element as shown by the arrows 583. The sensor 580 then provides signals indicative of the intensity and/or wavelength of reflected light reflected to the controller, allowing the controller to interpret the signals and hence the encoded markings

In the current example, the marking regions 581, 582 include a single elongate shaped marking region 581, and a number of dot shaped marking regions 582. In use the dot regions 582 may be selectively or differentially marked, for example with using dark colours shown at 582.1, or light colours (or no markings) shown at 582.2, to thereby encode binary data. Thus, selectively marking the marking regions 582 with different colours, contrasts or the like, can be used to encode data regarding the contents of the capsule in a binary form. In general, the elongate region 581 is utilized to indicate start/end point of the code.

Accordingly, in use, the code is read as the capsule 550 is rotated in either a clockwise or counterclockwise direction. In this instance, the controller (not shown) can activate a capsule drive (not shown) and cause rotation of the capsule 550 within the capsule holder. The sensor 580 is used to detect the presence of the elongate marking region 581 indicating that the reading of the code can now commence. The capsule 550 is then rotated, with each of the marking regions 582 being detected in turn, to thereby determine the encoded binary information indicative of the capsule content. In one particular example in which the capsule holder drive is a stepper motor, the spacing of the marking regions 582 can correspond to a single stepwise rotation of the stepper motor, such as 18°, so that the controller need only cause rotation of the stepper motor in incremental steps to bring each of the marking regions 582 into alignment with the sensor 580, in turn thereby allowing the code to be efficiently and accurately read. It will be appreciated however that other markings could be used depending on the preferred implementation.

A second specific example of an apparatus for dispensing beverage is shown in FIGS. 6A to 6C. The arrangement is similar to that described with reference to FIGS. 3A and 3B and can be used with receptacles 660 and capsules 650 similar to those described above with respect to FIGS. 4 and 5.

In this example the apparatus 600, includes a housing (not shown) a mounting support 613, capsule holder drive support (not shown) and a cup support 615, which are utilised for supporting the mounting 620, the capsule drive 632 and capsule holder 630. The apparatus 600 includes a mounting body 621, in the form of a generally cylindrical tubular body, including a rubber sealing ring for sealing engaging the base 663 of the receptacle 660. A bayonet 626 projects radially inwardly from the mounting body 621 to engage a recess in the receptacle base 663 and thereby maintain a desired orientation between the receptacle 660 and mounting body 621. The mounting body 621 also supports the outlet port 645 which engages a recess 663.1, to sealingly engage with the first conduit 361.

The mounting body 621 includes teeth 623 extending circumferentially around an outer surface of the body 621, which engage a gear 624 supported in a recess of the mounting support 613. The gear 624 is coupled to the mounting drive 622 via a worm gear (not shown), so that the mounting drive 622 can be rotated, thereby causing the mounting body 621 to be raised, as shown in FIG. 3B and lowered, as shown in FIG. 3C as required.

The capsule holder 630 includes a capsule holder drive stepper motor 632 coupled via a drive shaft 633 to a spindle 634, which is rotatably supported by the cup support 615 via ball bearings 635 and is magnetically coupled via magnets 636, 637 to the cup 631. The spindle has a profiled surface that engages with a correspondingly shaped portion of the cup 631, thereby transferring rotational torque from the drive shaft 633 to the cup 631.

It will be appreciated that the apparatus 600 functions substantially similarly to the previous examples and will not therefore be described in any further detail.

An example of the fluid supply will now be described with reference to FIGS. 7A to 7D.

In this example the fluid supply includes a reservoir 741 coupled by a flow meter 741.2 to a pump 742. The pump 742 is coupled via a first flow control valve 743.1 and a filter 745 to a second flow control valve 743.2. The second flow control valve connects to cold and hot fluid conduits 746, 747, which are in turn coupled by a third flow control valve 743.3 to the receptacle 760. A heater 744 is provided in the hot fluid conduit, with a sterilising conduit being provided from downstream of the heater to the first fluid control valve 743.1.

Initially, hot water is to be supplied. Accordingly, in this example the first, second and third flow control valves 743.1, 743.2, 743.3 are adapted to divert water from the reservoir 741, and pump 742, via the filter 745 and the hot fluid conduit 743.2, to the capsule, as shown in FIG. 7B. It will be appreciated that this arrangement can also be used to deliver steam to the capsule for purging, by appropriate control of the heater 744

In the arrangement in FIG. 7C the position of the second and third flow control valves 743.2, 743.3 is adjusted so that water flows via the cold fluid conduit 746, to the receptacle 760.

In the third example of FIG. 7D the position of each flow control valve 743.1, 743.2, 743.3 is adjusted so that water passes through the heater 744 whilst bypassing the filter 749, with steam returning to the first flow control valve 743.1, before passing through the filter 749 and the cold fluid conduit 746. This operates to flush the system with steam which can be used sterilising the fluid conduits, as well as providing steam to an accessory such as a steriliser.

Operation of a second example fluid supply will now be described with reference to FIGS. 7E to 7G.

In this example the fluid supply includes a reservoir 741 coupled by a flow meter 741.2 to a pump 742. The pump 742 is coupled via a first flow control valve 743.1, which is in turn coupled to a second flow control valve 743.2, to define cold and hot fluid conduits 746, 747, the hot fluid conduit 747 including a heater 744. The second flow control valve 743.2 is coupled to the outlet 745 via a filter 749, whilst a steam path 748 bypasses the filter.

When hot water is supplied, the first and second flow control valves 743.1, 743.2 direct water from the reservoir 741 and pump 742, to the bottle 760, via the hot water conduit 747, and filter 749, as shown in FIG. 7E. In the arrangement in FIG. 7F the position of the first and second control valves 743.1, 743.2 is adjusted so that water flows via the cold fluid conduit 746, and through the filter 749. In the configuration of FIG. 7E, the flow control valves 743.1, 743.2 are adjusted so that water passes through the heater 744 whilst bypassing the filter 749, thereby allowing the capsule to be purged, and or sterilisation to be performed, without damaging the filter.

A third example fluid supply system will now be described with reference to FIG. 7H.

In this example, the fluid supply 740 includes a reservoir 741 coupled via a one-way valve 743.4 to a flow meter 741.2, a pump 742, a filter 749 to a first flow control valve 743.1. The first flow control valve 743.1 is coupled to second flow control valve 743.2, to define cold and hot fluid conduits 746, 747, the hot fluid conduit 747 including a heater 744, and the cold fluid conduit including a one way valve 743.5. The second flow control valve 743.2 is coupled to the outlet 745 and hence the bottle 760. Additionally, the second flow control valve 743.2 is coupled via a flushing conduit 748.1 to a third flow control valve 743.4, which is in turn coupled either to a waste reservoir 741.1 or the flow meter 741.2.

In use, the first flow control valve 743.1 is used to control whether water flows through the hot or cold water conduits 747, 746, thereby allowing hot water, steam or cold water to be delivered to the bottle 760. In the arrangement in FIG. 7F the position of the first and second control valves 743.1, 743.2 is adjusted so that water flows via the cold fluid conduit 746, and through the filter 749. Additionally, flushing of the fluid system can be performed by using the second control valve 743.2 to direct water via the flushing conduit 748.1 and have this recirculate through the flow meter 741.2, pump 742, filter 749, first flow control valve 743.1 and then either the hot or cold water conduit 747, 746. This can be performed a number of times, before flushing water is delivered to the waste reservoir using the third flow control valve 743.3, allowing this to be disposed of. It will be appreciated that this allows the fluid supply system to be periodically cleaned. Additionally, all water supplied to the bottle 760 passes through the filter 749, thereby ensuring the water is suitably cleaned prior to use.

In either case, operation of the fluid supply system is controlled using a suitable controller, such as the controller 270 described above, to allow specific volumes and temperatures of fluid to be delivered to the capsule. The volumes and temperatures will vary depending on a range of factors, such as the volume of beverage to be dispensed, and the type of beverage, as well as the ambient temperature of fluid in the fluid reservoir.

Example volumes and temperatures for the hot and cold water flows, for a range of different bottle and beverage sizes for the preparation of infant formula are shown in Table 1 below:

TABLE 1

| | | Beverage | Hot | Hot | Cold | Cold | Bev- |
|---|---|---|---|---|---|---|---|
| Bottle | Water | target | water | water | water | water | erage |
| volume | added | temp. | volume | temp. | volume | temp. | temp |
| (ml) | (ml) | (° C.) | (ml) | (° C.) | (ml) | (° C.) | (° C.) |
| 90 | 81 | 37 | 20 | 75 | 61 | 25 | 37.3 |
| 100 | 90 | 37 | 20 | 75 | 70 | 27 | 37.7 |
| 133 | 120 | 37 | 25 | 75 | 95 | 27 | 37.0 |
| 167 | 150 | 37 | 30 | 75 | 120 | 28 | 37.4 |
| 200 | 180 | 37 | 35 | 75 | 145 | 28 | 37.1 |
| 233 | 210 | 37 | 40 | 75 | 170 | 29 | 37.8 |

The volume of powdered infant formula in the capsule will vary depending on the intended size of drink. For example, the capsule would typically contain 12 g of infant formula for a 90 ml bottle and 35 g for a 240 ml bottle. It will be appreciated that the above values are for the purpose of example only and that in practice, different temperatures and volumes could be used depending on the preferred implementation.

As previously described, the dispensing apparatus can be adapted to operate with one or more accessories. In one example, the accessory can be a steriliser having a steriliser body defining a steriliser cavity, the steriliser body including a fluid conduit for transferring steam from the fluid supply of the dispensing apparatus to the steriliser cavity. The fluid conduit can include a plurality of outlets for distributing steam within the steriliser cavity, whilst the cavity can contain at least one basket for receiving an article to be sterilised in use.

A specific example of a steriliser suitable for use in sterilising receptacles such as infant nursing bottles, will now be described with reference to FIGS. 8A to 8D.

In this example, the steriliser accessory includes a body 810 having a handle 811 and a cover 820 having a lid 821. In use, the cover 820 is removably mounted to the body 810 allowing a user to gain access to a cavity 830 containing first and second baskets 831, 832 and a pair of tongs 833. The body 810 includes a body base 812 defining a fluid conduit 813 extending from an outer perimeter of the base 812 to the cavity 830. The fluid conduit 813 includes an inlet 813.1 for coupling to a fluid system outlet, such as the outlet port 345, and multiple outlets 813.2, for distributing steam into the cavity 830. A baffle 813.3 may also be provided, for distributing steam through the fluid conduit 813.

In use, when a user wishes to sterilise a receptacle such as a nursing bottle, the cover 820 is separated from the body 810 to provide access to the cavity 830. The baskets 831, 832 are then removed and the bottle components positioned in the baskets 831, 832 as appropriate. Typically, the bottle body and base are provided in the first basket 831, with the teat portion being provided in the second basket 832, which can be stacked on top of the first basket 831, within the cavity 830. The tongs 833 are then typically positioned on top of the teat in the second upper basket 832.

The cover 820 is attached to the body 810, which is then coupled to the mounting 330 in a manner similar to that described above with respect to a receptacle. Thus, the steriliser base 810 will typically include flanges (not shown) that engage mounting flanges 321.2 in the mounting body 321. When correctly engaged, the fluid conduit inlet 813.1 engages with the outlet port 345 allowing steam to be supplied into the cavity 830. The dispensing apparatus 300 is then controlled by the controller to dispense a predetermined amount of steam to the cavity 830 over a set time period to ensure complete sterilisation of the nursing bottle or other receptacle or article.

Once completed, the user can remove the cover 820 and remove the tongs 833 from the basket 832. The baskets 831, 832 can then be separated and the tongs 833 used to lift the teat from the second basket 832 and fit this to the bottle body to thereby maintain sterility.

In another example, the accessory can include a food mixer having a mixer body defining a mixer cavity and blades rotationally mounted within the cavity, the blades being coupled to a blade drive shaft that mechanically connects to the capsule holder, to thereby allow rotation of the blades within the mixer cavity to be driven by rotation of the capsule holder. The blade drive shaft can be coupled to a cup insert that mechanically couples to a cup of the capsule holder, thereby allowing the blade drive shaft to be driven by rotation of the cup, although alternatively, the blade drive shaft may couple directly to the spindle by removing the cup from the dispensing apparatus.

In a further example, the accessory can include a food steamer having a steamer body defining a steamer cavity and including a fluid conduit for transferring steam from the fluid supply to the steamer cavity and a steamer tray supported within the steamer cavity in use, the steamer tray being for supporting foods to be steamed.

A second example of a beverage receptacle in the form of a nursing bottle will now be described with reference to FIGS. 9A to 9J.

For the purpose of this explanation it is assumed that the beverage receptacle is generally similar to that described above with respect to FIGS. 4A to 4H and similar reference numerals are therefore used albeit increased by 500. Accordingly, all of the features of the beverage receptacle will not be described in detail.

In any event, the beverage receptacle 960 includes a receptacle body 964 defining a receptacle cavity 965 and an opening for drinking the liquid beverage in the cavity, which in this example receives a teat 966.1, held in place using a teat mounting ring 966.2 coupled to screw threads 964.1 on the bottle body. These are typically industry standard teats and teat mountings and these will not therefore be described in further detail.

The bottle 960 includes a receptacle base 963 including first and second conduits 961, 962, the first conduit being coupled to a fluid supply that selectively supplies fluid to a capsule via the first conduit 961 to thereby dilute beverage concentrate contained in the capsule and supply the liquid beverage to the receptacle via the second conduit 962. The receptacle base 963 can be coupled to the receptacle body 964 using any appropriate arrangement, such as complimentary screw threads 964.2, 963.7, a friction fit, interference fit, or the like.

The first and second conduits 961, 962 have respective inlets at 961.1, 962.1 and outlets 961.2, 962.2. The first conduit inlet 961.1 is provided in an outer circumferential perimeter surface of the receptacle base 963, and receives an outlet port of the fluid supply system, allowing fluid to be delivered to the capsule in use.

The second fluid conduit 962 includes a one-way valve to prevent fluid flow from the beverage receptacle 960 to the capsule and allow air into the beverage receptacle 960 during consumption of the beverage. In one example, this is achieved by providing a second conduit outlet 962.2 in an outer circumferential surface of a valve hub 963.5 that extends upwardly from a substantially planar base surface 963.6. A sealing member 967 is provided that includes a sealing flange 967.2 extending around the outer surface of the valve hub 963.5 to thereby selectively seal the second conduit outlet 962.2 so that the valve is opened by an overpressure in the second conduit 962 urging the sealing flange 967.2 away from the second conduit outlet 962.2.

The sealing member 967 also includes an annular body 967.1 coupled to the sealing flange 967.2, the annular body 967.1 being provided on the planar base surface 963.6 outwardly of the valve hub 963.5 in use, wherein the annular body 967.1 seals an open channel 961.3 in the planar base surface 961.6, the channel 961.3 defining part of the first conduit 961. The annular body 967.1 typically includes a rigid plate 967.3 therein to provide rigidity to the annular body 967.1 so that when the receptacle body 964 engages the annular body 967.1, this urges the annular body 967.1 into engagement with the planar base surface 961.6, thereby sealing the channel 961.3. To assist with sealing the sealing member 967 is typically made of a soft or pliant rubber or polymer, with the plate 967.3 being made of stainless steel or the like, although it will be appreciated any suitable material could be used.

In any event, with the sealing member 967 in place, the first conduit 961 is closed and the second conduit outlet 962.2 is selectively sealed until the pressure in the second conduit 962 exceeds that in the receptacle cavity 965, at which point the sealing flange 967.2 is urged away from the second conduit outlet 962.2, allowing fluid flow into the cavity. In use, the sealing member 967 can be removed so that during cleaning the fluid conduit 961 and fluid conduit 962 are easily cleaned. Accordingly, this provides a bottle that is easy to dissemble and clean and yet provides a reliable seal for allowing fluid to enter the bottle through the conduit 962 whilst preventing fluid leaking from the bottle via the second conduit. However, it will be appreciated that this arrangement is not essential and the first conduit 961 could be closed, in which case the annular portion of the sealing member 967 would not be required.

The bottle base 963 further includes a convex capsule engaging ridge 963.1, with the first conduit outlet 961.2 and second conduit inlet 962.1 being provided in the ridge 963.1. The ridge is arranged so that when the receptacle base 963 and capsule engage, the ridge engages part of the pierceable capsule lid to thereby selectively deform at least one capsule side wall. This can help bring conduit capsule spikes into engagement with the capsule lid and/or control tension in the capsule lid, for example to prevent an over tension, to thereby assist in piercing the capsule lid. This allows the first conduit outlet 961.2 and second conduit inlet 962.1 to selectively couple to capsule fluid conduits in use, in a manner similar to that previously described.

In one example, the convex ridge 963.1 projects from and extends across a substantially planer under surface 963.2 of the base, whilst a base rim 963.3 is provided extending perpendicular from a perimeter of the base under surface 963.2, with the base rim 963.3 extending from the base under surface 963.2 a distance greater than that of the capsular engaging ridge 963.1. Base flanges 963.4 are provided extending outwardly from the base rim 963.3 for engaging the receptacle mounting on the beverage dispensing apparatus.

Further example capsules will now be described with reference to FIGS. 10A to 10I. In this example, the capsules are generally similar to the capsule described above with respect of FIGS. 5A to 5F, albeit with reference numerals increased by 500 and this will not therefore be described in major detail.

As in the previous examples, the capsule 1050 includes at least one capsule side wall 1051, a capsule base 1052 and a capsule lid 1053 defining a capsule cavity containing concentrated beverage.

In one example, the capsule includes first and second capsule conduits 1055, 1056 that in use selectively couple to first and second conduits 961, 962 in a beverage receptacle 960 so that when the first conduit 961 is coupled to a fluid supply, fluid is supplied to the capsule 1050 and the liquid beverage is supplied to the receptacle 960.

In one example, hot or unheated fluid is supplied to the capsule via the second capsule conduit 1056, unheated fluid or steam is supplied to the capsule via the first capsule conduit 1055 and the liquid beverage is supplied via the second capsule conduit 1056. In particular, hot fluid is supplied via the second capsule conduit 1056 to thereby dilute, dissolve or infuse the beverage concentrate, cold fluid is supplied via the first capsule conduit 1055 to thereby form the liquid beverage and at least partially discharge the liquid beverage via the second conduit 1056 and steam or air is supplied via the first capsule conduit 1055 to flush the capsule and thereby discharge the remaining liquid beverage via the second conduit 1056.

However, this is not essential, and alternatively fluid may be supplied by the first capsule conduit 1055 only, with beverage only being dispensed via the second capsule conduit 1056. In this regard, it will be appreciated that the first and second capsule conduits being able to “selectively” couple to first and second conduits in the receptacle merely requires that coupling occur between the conduits at some part during the beverage dispensing process. It will therefore be appreciated that the first and second capsule conduits may couple to either one or both of the first and second fluid conduits in the receptacle, depending on the particular implementation of the dispensing process being performed. In the preferred example, the first and second capsule conduits selectively couple to each of the first and second fluid conduits during different stages of the beverage dispensing operation, for example through disengagement of the capsule and receptacle, relative movement of the capsule and receptacle and subsequent reengagement of the capsule and receptacle.

In one example, the second capsule conduit 1056 extends substantially along a length of the capsule and terminates adjacent the capsule base 1052 allowing fluid to be dispensed from the capsule cavity via the second capsule conduit 1056 and the first capsule conduit 1055 is shorter than the second capsule conduit 1056 allowing fluid to be supplied to the capsule cavity away from the capsule base. In one particular example, the first capsule conduit 1055 extends from proximate the lid and terminates remote from the capsule base 1052, allowing fluid to supplied to the capsule via the second capsule conduit 1056, whilst avoiding fluid being dispensed from the capsule, due to separation of the first capsule conduit 1055 and the fluid in the capsule. It will be appreciated however that alternative arrangements could be used, such as having the first capsule conduit 1055 formed from an aperture in the lid 1053, as will be described in more detail below, or by providing capsule conduits of similar lengths.

In another example, the capsule includes a conduit body 1050.1 mounted in the capsule cavity that includes a first capsule conduit 1055 that in use supplies fluid to the capsule, a second capsule conduit 1056 that in use at least dispenses fluid from the capsule and a paddle 1057 for agitating contents of the capsule.

In one example, the capsule includes a conduit body 1050.1 mounted in the cavity, the conduit body 1050.1 including a first capsule conduit 1055 that in use supplies fluid to the capsule, a second capsule conduit 1056 that in use at least dispenses fluid from the capsule and arms 1059 ending in feet 1059.1 that engage an inner surface of the at least one capsule side wall 1051 to thereby support the conduit body 1050.1 within the capsule. Thus, in this example, the feet are used to mount the conduit body within the capsule, but other arrangements could be used. For example, ribs could be provided on the capsule base 1052 or side wall(s) 1051 for supporting the conduit body within the capsule cavity. Additionally, and/or alternatively the conduit body could be integrally formed with, conjoined or otherwise coupled to or mounted within the capsule cavity. Further, in this example, the paddle may not be required, or form part of the conduit body, for example in the event that the paddle is separately integrated into or coupled to the capsule side wall or base.

In another example, the capsule includes at least one capsule conduit 1056 provided within the capsule cavity, wherein in use the at least one capsule conduit receives fluid from a fluid supply and supplies beverage to a receptacle and at least one paddle 1057 for agitating contents of the capsule.

Thus, in the above examples, a paddle can be used to assist in agitating the contents of the capsule, and in particular the beverage concentrate and fluid, to thereby facilitate mixing and hence dilution of the beverage concentrate. However, it will be appreciated that agitation could be achieved using other mechanisms, such as an element for agitating the capsule contents. This could include one or more ribs provided on an inside of the one or more capsule side walls, to agitate contents upon movement of the capsule, or nozzles in the capsule conduits so that fluid entering the capsule forms jets to thereby agitate the capsule contents.

A number of further features of the current particular example will now be described.

In particular, in the current example, the capsule 1050 includes an insert in the form of a conduit body 1050.1 mounted in the cavity, the conduit body 1050.1 including the first and second capsule conduits 1055, 1056.

The conduit body 1050.1 includes arms 1059 ending in feet 1059.1 that engage an inner surface of capsule side wall 1051 to thereby support the conduit body 1050.1 within the housing. This can be achieved through the means of a snap-fit, friction-fit, interference-fit or the like, or alternatively can include bonding the conduit body 1050.1 to the side wall 1051, using an adhesive, heat or ultrasonic welding or the like. However, as described above any suitable mounting arrangement could be used, such as the use of ribs provided on an inner surface of the side wall 1051, or by forming the conduit body integrally within the capsule, for example as part of a 3-D printing process.

In the current particular example, the capsule 1050 includes recesses 1051.1 defining side wall pockets for receiving the feet 1059.1 and supporting the conduit body 1050.1 within the capsule 1050. This prevents movement of the conduit body 1050.1 during piercing of the capsule lid 1053, and helps ensure a fixed distance is maintained between the second conduit 1056 and the capsule base 1052. In this regard, the second conduit 1056 is typically spaced from the capsule base by a distance d that is less than 5 mm, more typically less than 2 mm and usually between 1 mm and 2 mm. This is performed to ensure that the second conduit 1056 does not seal against the capsule base 1052 thereby allowing free flow of fluid into and out of the second conduit 1056, whilst also minimising the distance between the capsule base and second capsule conduit, in order to maximise removal of fluid from the capsule.

The first capsule conduit 1055 is also typically shorter than the second capsule conduit 1056, so that the fluid to can be supplied via the first capsule conduit 1055 away from the capsule base 1052, whilst the second capsule conduit extends substantially along a length of the capsule and terminates adjacent the capsule base 1052 allowing fluid to be dispensed from the capsule via the second capsule conduit. The relative lengths of the conduits will vary depending on the preferred implementation and the capsule size. So for example, for the capsule of FIG. 10C, the first capsule conduit 1055 will typically be less than 40 mm, less than 30 mm, less than 20 mm, and more typically approximately 10 mm long. The second capsule conduit 1056 is longer than the first capsule conduit 1055 and can be greater than 20 mm, greater than 30 mm and more typically about 45 mm long (including the respective spikes 1055.1, 1056.1). In contrast for the capsule of FIG. 10D, whilst the first capsule conduit 1055 is of a similar size, the second capsule conduit 1056 is shorter allowing the to be accommodated within the capsule cavity and hence is approximately 30 mm long. It will be appreciated from this, that the second capsule conduit 1056 is typically sized to extend substantially along the length of the capsule, whilst the first capsule conduit 1055, need only be sufficiently long to allow for engagement with the fluid conduits 961, 962 in the receptacle base, and to extend into the capsule cavity through the lid 1053.

Additionally, the first capsule conduit 1055 can terminate adjacent to, or can include, a baffle or cavity 1058 to help direct fluid entering the cavity through the first capsule conduit 1055, as described with respect to the previous example.

At least one element is provided for agitating contents of the capsule, particularly upon reciprocating rotation of the capsule. The element could be of any suitable form and could include ribs or the baffles mounted to or integrally formed with an inner surface of the base and/or capsule side wall 1051. More typically however the element is a paddle 1057 is mounted within the capsule cavity, for example as part of a conduit body or another form of insert, although the paddle could also be integrated into or otherwise coupled to, mounted to, or conjoined with the side wall and/or base of the capsule.

The paddle 1057 is designed to ensure adequate mixing of liquid and in particular beverage concentrate and water to thereby dilute the beverage. To achieve this, the paddle typically covers between 30% to 95%, 40% to 80%, 50% to 70% or 60% to 70% of a vertical cross section of the capsule cavity. It will also be appreciated that the size chosen will depend on a range of factors including the design of the paddle, the mixing requirements and the amount or speed of rotation of the capsule. The effectiveness of the paddle will also depend on it's location in the cavity, with paddle surfaces provided near the base 1052 and side wall 1051 being more effective, and hence allowing overall surface area of the paddle to be reduced compared to if paddle surfaces are provided primarily within the centre of the capsule cavity. The degree of mixing can also be controlled by controlling a mixing time, so in the event that the paddle has a smaller effective cross sectional area, the mixing time used can be increased.

The paddle typically includes a plurality of, and typically at least 10, apertures, with at least some of the apertures having an area of less than 200 mm², less than 100 mm², less than 50 mm², and between 10 mm² and 40 mm². This helps ensure adequate flow of material through the apertures to ensure good mixing. The apertures are also typically spaced apart by at least one of 1 mm and 2 mm, which provides enough material between the apertures to maintain sufficient rigidity of the paddles 1057 for handling and mixing purposes, for example to prevent the conduit bodies becoming tangled when stacked for transport, whilst also minimising material usage in the paddle. The above arrangements result in a paddle having a total surface area in the region of greater than 1000 mm², more typically greater than 2000 mm², and approximately 2500 mm².

The paddles typically form part of the conduit body 1050.1, with two paddles 1057 being arranged on either side of the conduits 1055, 1056. The first and second capsule conduits 1055, 1056 are typically spaced apart about an axis of the capsule 1050, so that in use the first and second capsule conduits engage either the first or second conduit depending on a relative orientation of the receptacle and capsule. The conduits 1055, 1056 are also typically aligned on a plane orientated at 60° relative to the plane of the paddles 1057, to assist in correct orientation of the conduits relative to the receptacle, whilst maximising the available area for the paddles, and allowing for stacking of multiple conduit bodies 1050 for example during manufacture, storage or transport.

However, this is not essential and other configurations could be used for example by having one of the capsule conduits aligned on the capsule axis and the other spaced apart therefrom. In this example, the axially aligned capsule conduit could engage with an axially aligned fluid conduit, whilst the other capsule conduit engages with an annular fluid conduit spaced apart from the axially aligned fluid conduit. This makes the coupling between the capsule and receptacle rotationally invariant, meaning the relative orientation of the capsule and receptacle does not matter when coupling the capsule and receptacle.

The conduit body is typically moulded so that arms, paddles and conduits are integrally formed, and the conduit body and capsule are typically made of polypropylene, although any suitable material could be used. In this example, the capsule can be manufactured using thermoforming or injection moulding with an injection moulded conduit body, although any suitable technique such as high volume 3-D printing or the like could be used.

During manufacture, the capsule body is formed, the insert mounted therein, any infant formula added and then the capsule is sealed with the lid 1053 thereby retaining the infant formula therein. It will be appreciated that this is performed in sterile conditions to thereby ensure sterility of the infant formula.

In the current example, the capsule 1050 includes a piercable lid 1053 coupled to a rim 1051.3 extending radially outwardly from the capsule opening, although as will be described below with reference to FIGS. 12A to 12D, this is not essential and other arrangements can be used. In the event that a piercable lid is used, each capsule conduit 1055, 1056, has a spike 1055.1, 1056.1 that pierces the capsule lid. To achieve this, the capsule 1050, and more typically at least the side wall 1051 and rim 1051.3 are at least partially deformable so that in use, during engagement with a receptacle base 963, each capsule conduit 1055, 1056 pierces the capsule lid 1053. As part of this process, deformation of the capsule can assist in bringing the lid into engagement with the spikes, whilst also controlling tension in the capsule lid 1053, for example by restricting the maximum tension, to thereby assist in piercing the capsule lid.

The lid 1053 may also include one or more tabs (not shown) projecting beyond the rim 1051.3, to facilitate manual removal of the lid, for example in the event that access to the beverage concentrate is required when a dispensing machine is not available. This can be further assisted by selective bonding between the lid 1053 and the rim 1051.3, for example by having a weakened bond in the vicinity of the tab to make removal of the lid easier in that region. In one example, this is achieved by having the lid bonded to a first part of the rim with a first bond strength and to a second part of the rim with a second bond strength, the second bond strength being less than the first bond strength. Typically, the first part of the rim is an arcuate segment extending around more than half the circumference of the rim and the second part of the rim is an arcuate segment extending around less than half the circumference of the rim. This allows the lid to be lifted from the capsule in the region of the second bond, whilst the lid remains attached to the capsule in the region of the first bond. This can also be used to ensure only part of the lid is removed, thereby allowing the beverage concentrate to be poured out of the capsule, whilst ensuring the conduit body is retained therein.

In one example, the capsule also includes a lid engaging plate 1053.1, typically forming part of the conduit body 1050.1, that engages an underside of a capsule lid 1053 when a topside of the lid is engaged by the ridge 963.1 on the receptacle base 963. The first and second capsule conduits 1055, 1056 extend through the lid engaging plate 1053.1 so that the lid 1053 is sandwiched between the ridge 963.1 and the plate 1053.1 to thereby affect sealing between the capsule 1050 and the receptacle base 963. This helps ensure fluid is successfully transferred between the capsule 1050 and receptacle 960.

The capsule 1050 typically includes a shoulder 1051.2 extending circumferentially around the capsule side wall, the shoulder 1051.2 being for maintaining a spacing of capsule bodies when they are stacked for transport or storage, thereby making the capsules easier to separate. Additionally, the shoulder can advantageously also be used for at least partially supporting the capsule in a capsule holder, as will be described in more detail below. Using a shoulder to support the capsule within a capsule holder avoids the need for the capsule base 1052 to be supported by the capsule holder allowing a range of different capsule sizes to be accommodated within a common holder as shown for example in FIGS. 10C and 10D. The capsule 1050 also includes guides for aligning the capsule in a capsule holder, the guides being formed by the recesses 1051.1 which define the side wall pockets.

In one example, the capsule 1050 further includes coded data in the form of at least one control marking 1081, wherein in use production of the liquid beverage is at least partially controlled in accordance with the control marking, in a manner similar to that described above. Thus, the control marking 1081 can define coded data that encodes information regarding parameters that should be used in controlling the beverage dispensing process, such as the amount of water to be supplied to the capsule and the temperatures that should be used.

In one example, the control marking 1081 includes a barcode, which can be sensed by a barcode reader provided in the dispensing apparatus, allowing the control marking to be interpreted and used in controlling the beverage making process. The capsule 1050 may also include an alignment marking 1081.1 that can be detected during rotation of the capsule 1050. The control marking 1081 is positioned at a set position relative to the alignment marking 1081.1 so that sensing of the alignment marking can be used to align the control marking with a barcode sensor or the like, thereby ensuring accurate detection of the barcode. Alternatively however, the orientation of the capsule could be sensed by sensing the position of the barcode directly using the barcode sensor, as will be appreciated by persons skilled in the art. It will also be appreciated that other data encoding mechanisms similar to those described above in previous examples could also be used.

An example of the capsule holder will now be described with reference to FIGS. 11A to 11B. In this example the capsule holder is broadly similar to that described above with respect to FIGS. 3F to 3J albeit with similar features indicated by referenced numerals increased by 800 and these features will not therefore be described in detail.

In this example, the capsule holder includes a cup 1131 having a body 1131.1 with a socket 1131.2 provided on a base thereof. In this example the socket 1131.2 is hexagonal and acts as a female hub to receive a complimentary shaped male hub allowing torque to be transmitted to the cup as previously described. The cup body 1131.1 includes a rim including elevated and lowered recess portions 1131.3, 1131.4.

In use, the capsule is inserted into the cup 1131, so that the guides formed from the recesses 1051.1 align with the recessed portions 1131.4 as shown in FIG. 11B. Furthermore the shoulder 1051.2 of the capsule 1050 abuts against a lip 1131.8 on an inner surface of the cup 1131, thereby supporting the capsule 1050 within the cup 1131. In this configuration, when the receptacle base 963 engages with the capsule 1050, the convex ridge 963.1 aligns with recesses 1131.4 allowing the capsule 1050 to be deformed, with the ridge 963.1 being accommodated within the recesses 1131.4. It will be appreciated that this allows the capsule to be deformed, whilst also ensuring that the capsule conduits 1055, 1056 align with the first and second conduits 961, 962 in the receptacle base 963, due to the alignment between the guides 1051.1 and the recess portions 1131.4.

Additionally, the cup body 1131.1 also includes windows 1131.6 for sensing the the control marking 1081 and/or alignment marking 1081.1. In this regard, the control and/or alignment markings 1081, 1081.1 are provided on the capsule at a predefined location relative to the guides 1051.1, for example by printing, embossing or labelling the capsule in an appropriate manner, thereby ensuring the control and/or alignment markings 1081, 1081.1 align with the windows 1131.6 when positioned in the capsule holder 1130, allowing these to be detected by a sensors provided in the dispensing apparatus.

Otherwise, operation of the cup is substantially as described above with respect to the previous example and this will not therefore be described in any further detail.

A further example of a reusable capsule will now be described with reference to FIGS. 12A to 12D.

In this example reusable capsule 1250 includes a body 1251 having a side wall and a base defining a cavity for containing a beverage concentrate, a capsule lid 1253 that can be removably coupled to the capsule body to define a capsule cavity for receiving a concentrated beverage and at least one capsule conduit 1255, 1256 for dispensing a beverage to a receptacle.

By having a capsule lid 1253 that can be removably coupled to the capsule body 1251, this allows the capsule lid to be removed, a beverage concentrate such as infant formula, to be provided into the cavity before the capsule lid 1253 is replaced, allowing the capsule to be used in a manner similar to that described above with respect to previous capsules. Accordingly, it will be appreciated that this arrangement provides a re-useable capsule, avoiding the need to utilise disposable capsules.

The capsule is typically at least one of substantially non-deformable and substantially rigid, and may be formed from any suitable material, such as polypropylene, or the like, thereby allowing the capsule to be used multiple times.

In order to provide the removable lid, the body includes an opening for receiving a lid 1253. The opening and lid 1253 have complimentary O-ring seals 1251.1, 1253.5 provided thereon so that the body 1251 and lid 1253 sealingly engage.

As in previous examples, the capsule typically includes first and second capsule conduits 1255, 1256 with hot or unheated fluid is supplied to the capsule via the second capsule conduit 1256, unheated fluid or steam is supplied to the capsule via the first capsule conduit 1255 and the liquid beverage is dispensed via the second capsule conduit 1256, although any suitable arrangement can be used.

The lid 1253 includes apertures defining at least part of the first and second fluid conduits 1255, 1256. As in previous examples, the second capsule conduit is typically longer that the first capsule conduit 1255, in which case this can be supported by or form part of the lid 1253. The first capsule conduit 1255 may solely be formed by the opening, or may alternatively also extend from or be otherwise coupled to or mounted to the lid. However, in contrast to previous arrangements, when the receptacle base 963 engages with the capsule lid 1253, the receptacle base 963 can seal directly against the lid, thereby obviating the need for capsule conduit spikes, or capsule conduits that extend beyond the capsule lid.

Additionally, the capsule lid 1253 can further support a paddle 1257 positioned on an underside of the lid so that the paddle 1257 is positioned within the capsule cavity when the lid 1253 is coupled to the body 1251. Accordingly, in this example the lid 1253 provides the combined functionality of a lid 1053 and conduit body 1050.1 in the previous example, although it will be appreciated that the paddle can alternatively be supported or otherwise coupled to, mounted to or integral with the capsule side wall and/or base. In the current example, the paddle and conduit configurations are not described or shown in any detail, but it will be appreciated that in practice these could be similar to the configurations described above for the capsule 1050.

The lid 1253 includes a rim 1253.2 extending upwardly around at least part of the perimeter of the lid 1253 and including a recess portion 1253.3 for receiving the convex portion 963.1 of the receptacle base 963. The rim 1253.2 also includes protrusions 1251.1 for aligning the capsule 1250 within the cup 1131, so that the receptacle base correctly aligns with the capsule conduits 1255, 1256. It will also be appreciated however that as the capsule does not need to be deformed, the receptacle base 963 can include a flat underside to seal directly against the lid 1253.

Accordingly, it will be appreciated that this reusable capsule can be used instead of the previously described disposable capsules. In this example the lid can be removed and infant formula provided therein before the lid is replaced and the capsule inserted into the machine as previously described. Thus, operation of the beverage making process is not confined to single use disposable capsules.

A further example capsule will now be described with reference to FIGS. 13A to 13D. In this example, the capsules are generally similar to the capsule described above with respect of FIGS. 10A to 10I, albeit with reference numerals increased by 300.

As in the previous examples, the capsule 1350 includes a capsule body having at least one capsule side wall 1351 and a capsule base 1352, and a capsule lid 1353 defining a capsule cavity containing concentrated beverage. In this example, the lid includes pre-formed openings 1353.1, 1353.2, which prior to use are covered by a removable foil seal 1353.3.

The capsule again includes a conduit body 1350.1 including first and second capsule conduits 1355, 1356 and paddles 1357. The conduit body includes arms 1359, ending in feet 1359.1, which in use are positioned in pockets 1351.1 in the side wall 1351, thereby retaining the conduit body 1350.1 in a fixed position within the cavity. In this example, the capsule conduits 1355, 1356 terminate flush with an upper surface of the arms, which in use rest against an underside of the lid 1353.

It will also be appreciated that the capsule 1350 includes additional similar features, such as having the second conduit terminate adjacent the base 1352, and the presence of a baffle or chamber 1358 adjacent the end of the first capsule conduit 1355, thereby directing fluid entering the capsule cavity.

In use, the foil seal 1353.3 can be peeled from the lid 1353, thereby exposing the openings 1353.1, 1353.2, which align with the conduits 1355, 1356. The receptacle base can then be urged against the lid 1353, and sealingly engage with the conduits 1355, 1356, allowing the capsule to function as in the previous examples. In this example however, piercing of the lid 1353 and hence deformation of the capsule are not required. It will also be appreciated that the receptacle base and capsule holder could be modified to operate with the capsule 1350, for example by removing the ridge 963.1 and providing a flat bottomed receptacle base 963 and/or removing the recess portion 1131.4 from the rim of the capsule, although this is not essential.

Again, variations described above with respect to the other capsule examples, such as the presence of a paddle integrated into, coupled to or mounted to the capsule body could also be used. It will be appreciated from that this that a wide variety of capsule arrangements can be used.

As previously described, an antimicrobial filter can be incorporated into the dispensing apparatus, and an example of a filter arrangement will now be described with reference to FIGS. 14A to 14C.

In this example, the filter arrangement includes a filter cartridge 1410 which in use is mounted in a cartridge holder 1420, typically provided as part of the housing 310.

The filter cartridge 1410 includes a lid 1411 connected via a porous tube 1412 to a base 1414. A filter material 1430 is provided between the lid 1411 and base 1414, extending circumferentially around and radially outwardly of the tube 1412. The filter material is pleated to provide structural strength, as well as increasing the surface area of the filter material.

The lid 1411 includes a rim 1411.2 having screw threads 1411.3 on an outer surface thereof and a ridge 1411.1 allowing the lid 1411, and hence the cartridge 1410 to be rotated. An O-ring seal 1411.4 is provided on the lid adjacent the rim 1411.2. The base 1414 includes an inlet 1414.1 in fluid communication with the tube 1412, and having an O-ring 1414.2 mounted externally thereon.

The cartridge holder 1420 includes a generally cylindrical body 1421 adapted to receive the filter cartridge 1410 therein, the body 1421 having a shoulder 1421.2 extending around an inner surface thereof, proximate a first end of the body 1421 and adjacent a screw thread 1421.1. An outlet 1421.3 is provided in a second end of the body 1421 offset from an axis of the body 1421, the outlet 1421.3 having an O-ring 1421.4 mounted externally thereon, whilst an aperture 1421.5 contain an O-ring 1421.6 is provided in the second end of the body 1421 aligned with the axis.

In use, the cartridge 1410 is inserted into the cartridge holder 1420 so that the inlet 1414.1 extends through and seals with the aperture 1421.5. The lid 1411 is rotated so that the screw threads 1411.3 engage the corresponding screw threads 1421.1 of the cartridge holder 1420, thereby securing the filter 1410 in place, with the O-ring 1411.4 sealing against the shoulder 1421.2.

The inlet 1414.1 and outlet 1421.5 are then connected to the fluid circuit via tubes that seal with the respective O-rings 1414.2, 1421.4, with the inlet 1414.1 being connected downstream of a pump, such as the pump 742 and the outlet being provided upstream of flow valves 743.1 and the heater 744. Accordingly, water from the reservoir 741 is pumped into the inlet 1414.1, passing through the tube 1412 and filter 1430, and entering a cavity between the filter cartridge 1410 and cartridge holder 1420, before exiting the filter arrangement via the outlet 1421.5. Accordingly, it will be appreciated that this provides a mechanism for filtering all water supplied from the reservoir, whilst also allowing the filter to be easily replaced as required. It will also be appreciated that the roles of the inlet and outlet may be reversed depending on the preferred implementation.

An example of a fluid supply system will now be described with reference to FIGS. 15A and 15B.

In this example, the fluid supply system includes a pair of conjoined plates 1511, 1512. At least one of the plates 1511, 1512, includes channels 1513 defining fluid conduits positioned between and defined by the plates and at least one of the plates 1511, 1512 supporting components of the fluid supply system including at least one of flow control valves 1543.1, 1543.2 and a filter 1549. The components are provided in fluid communication with the channels 1513 thereby allowing the components to be interconnected as required allowing fluid, and in particular water, to be supplied for use in a beverage dispensing operation.

The use of plates 1511, 1512 including channels that define the fluid conduits makes construction of the fluid supply system easy, whilst also ensuring a high degree of reliability and cleanliness. In particular, the plates can be precast or moulded and then simply joined and sealed, for example using welding, adhesion and/or other fixing techniques such as bolting the plates together. Before, during or after this process, components can be attached to the plates, and subsequent tubes then coupled to the connectors, thereby forming the fluid supply system.

A number of further features will now be described.

Typically the fluid supply system includes channels 1513 on each of the plates 1511, 1512, in which case components can be mounted on a first plate 1511, with the first plate 1511 including apertures connecting the components to channels 1513 in the second plate 1512.

In the current example, the fluid supply system includes an inlet tube 1541 for coupling to a reservoir containing fluid in use, a pump 1542 that receives fluid from the reservoir, a filter 1549 that filters fluid received from the pump, a first flow control valve 1543.1 that receives fluid from the filter and selectively outputs fluid to hot and cold fluid conduits, a heater 1544 in thermal communication with the hot fluid conduit and an outlet tube 1545 that provides fluid from either the hot or cold fluid conduit for use in dispensing a beverage.

In particular, the inlet tube 1541 is connected to a flow meter 1541.1 having a flow meter outlet tube 1541.2 that extends to the pump 1542. The pump 1542 has a pump outlet tube 1542.1 connected to a filter inlet 1549.1, whilst a filter outlet 1549.2 is in fluid communication with a first channel 1513.1 in the second plate 1512.

The first channel 1513.1 is in fluid communication with the first flow control valve 1543.1, which in turn is connected to a cold water tube 1546.1 and via a hot water connector 1547.2 to a hot water tube 1547.2. The hot water tube 1547.2 is coupled to the heater 1544, which is in turn connected via a second hot water tube 1547.3 to a second hot water connector 1547.4 and in turn to a second channel 1513.2. The cold water tube 1546.1 is also connected via a cold water connector 1546.2 to the second channel 1513.2, with the second channel 1513.2 being connected to the second flow control valve 1543.2. The cold and second hot water connectors 1546.2, 1547.4 also incorporate one-way valves 1543.5, 1543.6 in the form of seals, such as bearings, biased by springs into engagement with a seat within the cold and second hot water connectors 1546.2, 1547.4, thereby preventing water within the second channel 1513.2 flow into the old water tube 1546.1 or the second hot water tube 1546.1.

The second flow control valve 1543.2 is coupled to the outlet tube 1545 and also via a third channel 1513.3 and a flushing connector 1548.1 to a flushing tube 1548.2. The flushing tube can form part of a flushing conduit, coupled via a third flow control valve (not shown in this example) to a waste reservoir.

Accordingly, it will be appreciated that the above described fluid supply system can function substantially similarly to the arrangements described above with respect to FIGS. 7A to 7H and will not therefore be described in further detail.

The above examples describe a number of features. It should be understood that features from different examples and within examples can be used independently, or in conjunction and that reference in combination within other features is not intended to be limiting.

In one example, the apparatus for dispensing liquid beverage, could include a housing, a capsule holder use receives a capsule containing concentrated beverage, a capsule holder drive that moves the capsule holder relative to the housing to thereby at least partially rotates the capsule holder in a reciprocating manner to thereby agitate fluid within the capsule, a mounting that in use receives a receptacle, and a fluid supply that selectively supplies fluid to the capsule to thereby dilute the concentrated beverage and supply liquid beverage to the receptacle.

In another example, the apparatus for dispensing liquid beverage, the apparatus could include including a housing, a capsule holder that in use receives a capsule containing concentrated beverage, a mounting that in use selectively a receptacle and an accessory and a fluid supply that selectively supplies fluid to the capsule to thereby dilute the concentrated beverage and supply liquid beverage to the receptacle or supplies steam to the accessory.

In another example the apparatus for dispensing liquid beverage includes a housing, a capsule holder that in use receives a capsule containing concentrated beverage, a mounting that in use selectively a receptacle, a fluid supply for supplying fluid at first and second temperatures and a controller that moves the receptacle into engagement with the capsule in a first orientation so that heated fluid is supplied to the capsule and moves the receptacle into engagement with the capsule in a second orientation so at least one of unheated fluid and steam is supplied to the capsule, with liquid beverage being supplied to the receptacle from the capsule.

In another example the apparatus for dispensing liquid beverage includes a controller including an electronic processing device that controls one or more drives that move at least one of the capsule holder and mounting and the fluid supply to thereby urge the receptacle into engagement with the capsule, supply fluid at first temperature to the capsule to at least partially dilute the concentrated beverage, urge the receptacle and capsule out of engagement, reciprocate the capsule to thereby agitate fluid within the capsule, urge the receptacle into engagement with the capsule and supply fluid at second temperature lower than the first temperature to thereby urge liquid beverage into the receptacle.

In another example a capsule for use in apparatus for dispensing liquid beverage includes capsule side walls, a capsule base and a pierceable capsule lid defining a capsule cavity containing concentrated beverage, wherein the capsule is at least partially deformable so that in use, during engagement with a bottle, at least one conduit within the capsule at least one of pierces the capsule lid and deforms the capsule base.

In another example, a capsule for use in apparatus for dispensing liquid beverage includes capsule side walls, a capsule base and a pierceable capsule lid defining a capsule cavity containing concentrated beverage, at least one fluid conduit provided within the capsule cavity, wherein in use the at least one fluid receives fluid from a fluid supply and supplies beverage to a receptacle and at least one paddle for agitating contents of the capsule.

In another example, a capsule for use in apparatus for dispensing liquid beverage includes capsule side walls, a capsule base and a pierceable capsule lid defining a capsule cavity containing concentrated beverage and first and second capsule conduits, the first capsule conduit terminating offset from the base of the capsule and wherein the first capsule conduit terminates adjacent a baffle to thereby direct fluid entering the capsule.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

1.-49. (canceled)

50. A capsule for use in apparatus for dispensing liquid beverage, the capsule including:
a) at least one capsule side wall, a capsule base and a capsule lid defining a capsule cavity containing concentrated beverage; and,
b) first and second capsule conduits wherein:
i) the second capsule conduit extends substantially along a length of the capsule and terminates adjacent the capsule base allowing fluid to be dispensed from the capsule cavity via the second capsule conduit; and,
ii) the first capsule conduit is shorter than the second capsule conduit and extends from proximate the lid and terminates remote from the capsule base allowing fluid to be supplied to the capsule cavity away from the capsule base.

51. A capsule according to claim 50, wherein the first and second capsule conduits are spaced apart about an axis of the capsule, so that in use the first and second capsule conduits can engage either the first or second receptacle conduit depending on a relative orientation of the receptacle and capsule.

52. A capsule according to claim 50, wherein hot or unheated fluid is supplied to the capsule via the second capsule conduit, unheated fluid or steam is supplied to the capsule via the first capsule conduit and the liquid beverage is supplied via the second capsule conduit.

53. A capsule according to claim 50, wherein the first capsule conduit terminates adjacent a baffle or chamber to thereby direct at least one of air and steam entering the capsule.

54. A capsule according to claim 50, wherein the first and second capsule conduits in use selectively couple to first and second conduits in a beverage receptacle so that when the first conduit is coupled to a fluid supply, fluid is supplied to the capsule and the liquid beverage is supplied to the receptacle.

55. A capsule according to claim 50, wherein the capsule includes at least one paddle for agitating contents of the capsule upon reciprocating rotation of the capsule.

56. A capsule according to claim 55, wherein the paddle includes a plurality of apertures.

57. A capsule according to claim 50, wherein the capsule includes at least one of:
a) a piercable lid; and,
b) a pre-pierced lid.

58. A capsule according to claim 57, wherein each capsule conduit has a spike that pierces the capsule lid and wherein the capsule is at least partially deformable so that in use, during engagement with a receptacle base, each capsule conduit pierces the capsule lid.

59. A capsule according to claim 57, wherein the capsule includes a lid engaging plate that engages an underside of a capsule lid when a topside of the lid is engaged by a receptacle base to thereby effect sealing between the capsule and the receptacle base and wherein the first and second capsule conduits extend through the lid engaging plate.

60. A capsule according to claim 50, wherein the capsule includes a conduit body mounted in the cavity, the conduit body including the first and second capsule conduits and wherein the conduit body includes arms ending in feet that engage an inner surface of the at least one capsule side wall to thereby support the conduit body within the housing.

61. A capsule according to claim 60, wherein the capsule includes at least one of recesses defining side wall pockets for receiving the feet and for supporting the conduit body within the capsule and ribs for supporting the conduit body within the capsule cavity.

62. A capsule according to claim 60, wherein the conduit body includes at least one paddle.

63. A capsule according to claim 50, wherein the capsule includes a rim extending radially outwardly from a capsule opening, the lid being coupled to the rim and wherein the lid is selectively coupled to the rim to thereby allow for at least partial removal of the lid thereby allowing beverage concentrate to be removed from the capsule.

64. A capsule according to claim 50, wherein the capsule includes a shoulder extending circumferentially around the capsule side wall, the shoulder being for at least one of:
a) partially supporting the capsule in a capsule holder in use; and,
b) spacing the capsules during stacking of the capsules for transport or storage.

65. A capsule according to claim 50, wherein the capsule is at least one of a single-use disposable capsule and a substantially non-deformable reusable capsule having a lid removably mounted to a capsule body, the capsule body including the at least one side wall and base, and the lid including apertures defining at least part of the first and second capsule conduits and the second capsule conduit and at least one paddle are supported by the lid.

66. A capsule according to claim 50, wherein at least one of:
the first capsule conduit has a length that is at least one of:
a) less than 40 mm;
b) less than 30 mm;
c) less than 20 mm; and
d) approximately 10 mm long; and
the second capsule conduit has a length that is at least one of:
e) greater than 20 mm;
f) approximately 30 mm;
g) greater than 30 mm; and
approximately 45 mm.

67. Apparatus for dispensing a liquid beverage, the apparatus including:
a) a receptacle including:
i) a receptacle body defining a receptacle cavity for receiving a liquid beverage;
ii) an opening for drinking beverage in the cavity; and,
iii) a receptacle base including first and second conduits, the first conduit being coupled to a fluid supply that selectively supplies fluid to a capsule via the first conduit to thereby dilute beverage contained in the capsule and supply liquid beverage to the receptacle via the second conduit.
b) a capsule including:
i) capsule side walls, a capsule base and a capsule lid defining a capsule cavity containing concentrated beverage; and,
ii) first and second capsule conduits that in use selectively couple to first and second conduits in a beverage receptacle so that when the first conduit is coupled to a fluid supply fluid is supplied to the capsule and liquid beverage is supplied to the receptacle.
c) a dispensing apparatus for dispensing liquid beverage, the apparatus including:
i) a capsule holder that in use receives the capsule containing concentrated beverage;
ii) a mounting that in use receives the receptacle having a base including first and second fluid conduits;
iii) a fluid supply that selectively supplies fluid at first and second temperatures to the capsule via the first conduit to thereby dilute the beverage and supply liquid beverage to the receptacle via the second conduit.

68. Apparatus according to claim 67, wherein the dispensing apparatus includes at least one of:
a) a capsule holder drive that moves the capsule holder relative to the housing to thereby at least partially rotates the capsule holder in a reciprocating manner to thereby agitate fluid within the capsule; and,
b) a controller that at least one of:
i) moves the receptacle into engagement with the capsule in a first orientation so that heated fluid is supplied to the capsule; and,
ii) supplies fluid at a first temperature to the capsule to at least partially dilute the concentrated beverage;
iii) moves the receptacle out of engagement with the capsule;
iv) reciprocates the capsule to thereby agitate fluid within the capsule;
v) moves the receptacle into engagement with the capsule; and,
vi) supplies fluid at second temperature lower than the first temperature to thereby urge liquid beverage into the receptacle.
vii) moves the receptacle into engagement with the capsule in a second orientation so at least one of unheated fluid and steam is supplied to the capsule, with liquid beverage being supplied to the receptacle from the capsule.

69. Apparatus for dispensing liquid beverage, the apparatus including:
a) a capsule holder that in use receives a capsule containing concentrated beverage;
b) a mounting that in use selectively receives at least one of a receptacle and an accessory;
c) a fluid supply that:
i) selectively supplies fluid to the capsule to thereby dilute the concentrated beverage and supply liquid beverage to the receptacle; and
ii) supplies steam to the accessory.
